(19) United States
(12) Patent Application Publication
(10) Pub. No.: US 2026/0042297 A1
(43) Pub. Date: Feb. 12, 2026

(54) DEFECTIVE NOZZLE DETECTION METHOD

(71) Applicant: SCREEN Holdings Co., Ltd., Kyoto (JP)

(72) Inventor: Asuka MURAMATSU, Kyoto-shi (JP)

(21) Appl. No.: 19/278,981

(22) Filed: Jul. 24, 2025

(30) Foreign Application Priority Data
Aug. 9, 2024 (JP) 2024-133931

(51) Int. Cl. B41J 2/21

(52) U.S. Cl. CPC B41J 2/2142; B41J 2202/21

(57) ABSTRACT

A theoretical value and an actual value of an interval between two linear patterns included in a test chart are calculated. For each linear pattern, a first error between an interval with a left adjacent linear pattern and the theoretical value, a second error between an interval with a right adjacent linear pattern and the theoretical value, and an average error between the first error and the second error are calculated. An actual position of the linear pattern where the minimum average error is obtained is set as a reference position. An ideal position of each linear pattern is calculated based on the reference position. A difference between the ideal position and a position in a captured image is calculated for each linear pattern, and whether or not a nozzle corresponding to each linear pattern is a defective nozzle is determined based on the difference.

### CROSS-REFERENCE TO RELATED APPLICATIONS

This application claims priority to Japanese Patent Application No. 2024-133931 titled “DEFECTIVE NOZZLE DETECTION METHOD AND PRINTING APPARATUS” filed on Aug. 9, 2024, the content of which is incorporated herein by reference.

### BACKGROUND OF THE INVENTION

### Field of the Invention

The present invention relates to a printing apparatus including an ink ejection head (print head) provided with a large number of nozzles that eject ink, and more particularly to a technique for detecting a nozzle in an ejection failure state (hereinafter, the nozzle in the ejection failure state is referred to as a “defective nozzle”) in such a printing apparatus.

### Description of Related Art

An inkjet printing apparatus that performs printing by ejecting ink onto a print medium such as printing paper and a film by heat and pressure is widely known. The inkjet printing apparatus includes, for example, a head unit for each color of ink, the head unit including a plurality of ink ejection heads extending in a direction orthogonal to a conveyance direction of the print medium (hereinafter, the direction orthogonal to the conveyance direction of the print medium is referred to as a “paper width direction”). Each ink ejection head includes a large number of nozzles that eject ink. Then, the gradation of a print image is expressed by controlling on/off of the ejection of ink from each of the large number of nozzles, or by controlling a drop size (droplet size) of the ink ejected from each of the large number of nozzles in a plurality of stages.

In the inkjet printing apparatus, when an ejection interval (a time interval, not a spatial interval) becomes long, drying of the ink due to evaporation of a solvent in the vicinity of a nozzle, mixing of air bubbles into the nozzle, adhesion of dust to the nozzle, and the like may occur during a period in which printing is performed. That is, an ejection failure of the nozzle may occur. When the ejection failure occurs, a defect of the print image such as a white streak or a dot missing occurs. In such a case, for example, an operation (cleaning or flushing) for recovering a function of the defective nozzle and an alternative droplet ejection in which ink droplets to be ejected by the defective nozzle are ejected by another nozzle are performed.

Meanwhile, in order to prevent a defect from being included in a print image shipped as an actual product, detecting a defective nozzle is performed on the basis of a captured image (captured data) obtained by capturing a print image of a test chart with an imaging device (in-line scanner or the like). FIG. 31 is a diagram schematically illustrating an example of a part of the test chart 90. The test chart 90 is configured by a stepwise regular pattern including a large number of linear patterns 9 extending in the conveyance direction of the printing paper. Each linear pattern 9 is formed by ejecting ink from one nozzle a plurality of times in succession. In the example illustrated in FIG. 31, the test chart 90 is divided into five blocks 91(1) to 91(5) each including eight linear patterns 9. The eight linear patterns 9 included in each block 91 are arranged at equal intervals in the paper width direction.

Assuming that the test chart 90 illustrated in FIG. 31 is used, a conventional method of detecting a defective nozzle will be described. Note that, although it is assumed here that the range illustrated in FIG. 31 is an inspection range, the actual inspection range includes a larger number of linear patterns 9. Furthermore, hereinafter, a coordinate in the paper width direction is an X coordinate, and a coordinate in the conveyance direction of the printing paper is a Y coordinate.

When the captured image of the print image of the test chart 90 is obtained, a length of the inspection range in the paper width direction and the number of linear patterns 9 per block (in other words, the number of nozzles per block) are obtained on the basis of the captured image. As a result, further, a theoretical value of the interval between the two linear patterns 9 adjacent in the paper width direction is obtained. Then, with the position (position in the captured image) of the linear pattern 9 at a left end of each block 91 (the linear pattern 9 included in a dotted line portion denoted by reference sign 92 in FIG. 31) as a reference position, by adding an integral multiple of the theoretical value (in this example, 1 to 7 times the theoretical value) to the coordinate value (X coordinate value) of the reference position, an ideal position where each of the 2nd to 8th linear patterns 9 from the left of each block 91 is to be formed is obtained. If the length of the inspection range in the paper width direction is 40 (here, the unit of length is omitted), since the number of linear patterns 9 per block is 8, the theoretical value of the interval between the two linear patterns 9 adjacent in the paper width direction is 5. In this case, if the X-coordinate value of the linear pattern 9 at the left end of the block 91(2) is 2, for example, the X-coordinate of the ideal position of the fifth linear pattern 9 from the left of the block 91(2) is calculated to be 22. After the ideal position of each linear pattern 9 is obtained in this manner, whether or not the nozzle corresponding to each linear pattern 9 is a defective nozzle is determined by comparing the ideal position with the actual position in the captured image for each linear pattern 9. In this regard, for example, in a case where the linear pattern 9 corresponding to a certain nozzle does not exist within a predetermined range from the ideal position, it is determined that the nozzle has caused non-ejection in which no ink is ejected at all, and in a case where the actual position of the linear pattern 9 corresponding to a certain nozzle is separated from the ideal position by a predetermined distance or more, it is determined that the nozzle has caused a landing position shift.

Note that, in relation to the present invention, Japanese Laid-Open Patent Publication No. 2011-201051 discloses a method of accurately specifying a reference position for obtaining a position of each line (linear pattern) constituting a test pattern (test chart) even in a case where resolution of a read image (captured image) is low. According to this method, reference position detection bars which are solid images are provided at an upper part and a lower part of the test pattern, and projection graphs of optical densities regarding the X direction and the Y direction are created for regions of corners (four corners) of the test pattern. Then, the X coordinate value and the Y coordinate value of each corner of the test pattern are obtained by detecting an edge whose density changes in each projection graph, and the X coordinate value and the Y coordinate value are used as a reference position.

However, according to the conventional method of detecting a defective nozzle, in a case where the nozzle corresponding to the linear pattern 9 at an end portion (in the above example, a left end) of each block 91 is a defective nozzle, the ideal position of each linear pattern 9 cannot be correctly obtained. For example, in a case where a nozzle corresponding to the linear pattern 9 at the end portion causes non-ejection as indicated by a dotted line portion denoted by reference sign 95 in FIG. 32 or in a case where a nozzle corresponding to the linear pattern 9 at the end portion causes a landing position shift as indicated by a dotted line portion denoted by reference sign 96 in FIG. 33, the ideal position of each linear pattern 9 cannot be correctly obtained. Furthermore, in the method disclosed in Japanese Laid-Open Patent Publication No. 2011-201051, if the nozzle corresponding to the end portion of the reference position detection bar is a defective nozzle, the projection graph is not accurately created, and thus the X coordinate value of the corner of the test pattern cannot be correctly detected. Therefore, the position (ideal position) of each line cannot be correctly obtained. From the above, conventionally, a defective nozzle cannot be detected with sufficient accuracy.

### SUMMARY OF THE INVENTION

Therefore, an object of the present invention is to enable detection of a defective nozzle with higher accuracy than before regarding a printing apparatus.

One aspect of the present invention is directed to a defective nozzle detection method of detecting a defective nozzle in a printing apparatus including a print head including a plurality of nozzles arranged in a first direction and configured to perform printing on a print medium by ejecting ink from the plurality of nozzles, the defective nozzle detection method including: printing a test chart including a plurality of linear patterns to be formed by ejecting ink from the plurality of nozzles and configured to be divided into a plurality of blocks in a second direction orthogonal to the first direction while relatively moving a positional relationship between the print head and the print medium in the second direction, each of the plurality of blocks including N linear patterns (N is an integer of 4 or more) to be formed so that an interval between two linear patterns adjacent in the first direction is constant;
acquiring a captured image by capturing a print image obtained by the printing the test chart;
calculating a theoretical value of the interval between the two linear patterns adjacent in the first direction;
calculating an actual value of an interval between the two linear patterns constituting a linear pattern pair on a basis of the captured image for each of (N−1) linear pattern pairs constituted by the N linear patterns included in each of the plurality of blocks, the linear pattern pair being a combination of the two linear patterns adjacent in the first direction;
calculating a first error, a second error, and an average error for each of (N−2) linear patterns excluding linear patterns at both ends among the N linear patterns included in each of the plurality of blocks, the first error being a difference between the theoretical value and an actual value for a first linear pattern pair, the second error being a difference between the theoretical value and an actual value for a second linear pattern pair, the average error being an average of the first error and the second error, the first linear pattern pair being one of two linear pattern pairs including each linear pattern excluding the linear patterns at both ends among the N linear patterns, and the second linear pattern pair being another of the two linear pattern pairs;
setting, for each of the plurality of blocks, an actual position of a linear pattern in which a minimum average error is obtained by the calculating the first error, the second error, and the average error among the (N−2) linear patterns as a reference position;
calculating an ideal position at which each linear pattern is to be formed, on a basis of the reference position;
calculating a difference in the first direction between the ideal position and the actual position based on the captured image for each linear pattern; and
determining whether or not a nozzle corresponding to each linear pattern is a defective nozzle on a basis of the difference.

According to such a configuration, on the basis of the captured image of the print image of the test chart divided into the plurality of blocks in a direction orthogonal to a direction in which the plurality of nozzles is arranged, for each linear pattern (excluding the linear patterns at both ends) included in each of the plurality of blocks, an average error representing how close the interval with two linear patterns each adjacent in the direction in which the plurality of nozzles is arranged is to the theoretical value is calculated. Then, the actual position of the linear pattern from which the minimum average error is obtained is set as the reference position, and the ideal position of each linear pattern is calculated on the basis of the reference position. Therefore, unlike the conventional method, even if the nozzle corresponding to the linear pattern at the end portion of each block is a defective nozzle, the reference position in each block can be correctly obtained, so that the ideal position of each linear pattern can be correctly obtained. As a result, the difference (the difference in the direction in which the plurality of nozzles is arranged) between the actual position and the ideal position of each linear pattern is accurately calculated, so that whether or not the nozzle corresponding to each linear pattern is a defective nozzle can be accurately determined. As above, regarding the printing apparatus, it is possible to detect a defective nozzle with higher accuracy than before. Therefore, since wasteful consumption of print media and ink caused by reprinting is suppressed, it is possible to contribute to the achievement of sustainable development targets (SDGs).

Another aspect of the present invention is directed to a defective nozzle detection method of detecting a defective nozzle in a printing apparatus including a print head including a plurality of nozzles arranged in a first direction and configured to perform printing on a print medium by ejecting ink from the plurality of nozzles, the defective nozzle detection method including:
printing a test chart including a plurality of linear patterns to be formed by ejecting ink from the plurality of nozzles and configured to be divided into a plurality of blocks in a second direction orthogonal to the first direction while relatively moving a positional relationship between the print head and the print medium in the second direction, each of the plurality of blocks including N linear patterns (N is an integer of 4 or more) to be formed so that an interval between two linear patterns adjacent in the first direction is constant;
acquiring a captured image by capturing a print image obtained by the printing the test chart;
calculating a theoretical value of the interval between the two linear patterns adjacent in the first direction;
calculating an actual value of an interval between the two linear patterns constituting a linear pattern pair on a basis of the captured image for each of (N−1) linear pattern pairs constituted by the N linear patterns included in each of the plurality of blocks, the linear pattern pair being a combination of the two linear patterns adjacent in the first direction;
calculating a first error, a second error, and an average error for each of (N−2) linear patterns excluding linear patterns at both ends among the N linear patterns included in each of the plurality of blocks, the first error being a difference between the theoretical value and an actual value for a first linear pattern pair, the second error being a difference between the theoretical value and an actual value for a second linear pattern pair, the average error being an average of the first error and the second error, the first linear pattern pair being one of two linear pattern pairs including each linear pattern excluding the linear patterns at both ends among the N linear patterns, and the second linear pattern pair being another of the two linear pattern pairs;
setting a reference position for each of the plurality of blocks;
calculating an ideal position at which each linear pattern is to be formed, on a basis of the reference position;
calculating a difference in the first direction between the ideal position and the actual position based on the captured image for each linear pattern; and
determining whether or not a nozzle corresponding to each linear pattern is a defective nozzle on a basis of the difference,
wherein the plurality of blocks is K blocks (K is an integer of 3 or more),
the test chart is configured such that N linear patterns included in a Pth block are formed at positions shifted by a certain distance in the first direction from N linear patterns included in a (P−1)th block, the P being an integer of 2 or more and K or less,
for a first block, a Kth block, and a block in which a minimum average error obtained by the calculating the first error, the second error, and the average error is less than or equal to a predetermined threshold, in the setting the reference position, an actual position of a linear pattern in which a minimum average error is obtained by the calculating the first error, the second error, and the average error among the (N−2) linear patterns is set as the reference position, and
for a Qth block in which a minimum average error obtained by the calculating the first error, the second error, and the average error is larger than the predetermined threshold, in the setting the reference position, when an average error obtained by the calculating the first error, the second error, and the average error for a Jth linear pattern included in a (Q−1)th block is less than or equal to the predetermined threshold, and an average error obtained by the calculating the first error, the second error, and the average error for a Jth linear pattern included in a (Q+1)th block is less than or equal to the predetermined threshold, the reference position is set on a basis of an actual position of a linear pattern included in the (Q−1)th block and an actual position of a linear pattern included in the (Q+1)th block, the Q being an integer of 2 or more and (K−1) or less, and the J being an integer of 2 or more and (N−1) or less.

According to such a configuration, for each linear pattern (excluding linear patterns at both ends) included in each of the plurality of blocks in the captured image of the print image of the test chart, an average error representing how close the interval with each of two adjacent linear patterns is to the theoretical value is calculated, and for a block in which a minimum average error is larger than a predetermined threshold, the reference position is set on the basis of the positions of the linear patterns in two adjacent blocks. Therefore, even for a block in which a linear pattern pair (two adjacent linear patterns) having an interval close to the theoretical value does not exist, the ideal position of each linear pattern is correctly obtained.

Still another aspect of the present invention is directed to a defective nozzle detection method of detecting a defective nozzle in a printing apparatus including a print head including a plurality of nozzles arranged in a first direction and configured to perform printing on a print medium by ejecting ink from the plurality of nozzles, the defective nozzle detection method including:
printing a test chart including a plurality of linear patterns to be formed by ejecting ink from the plurality of nozzles and configured to be divided into a plurality of blocks in a first direction while relatively moving a positional relationship between the print head and the print medium in a second direction orthogonal to the first direction, each of the plurality of blocks including N linear patterns (N is an integer of 4 or more) to be formed so that an interval between two linear patterns whose positions in the second direction are adjacent is constant;
acquiring a captured image by capturing a print image obtained by the printing the test chart;
calculating a theoretical value of the interval between two linear patterns whose positions in the second direction are adjacent;
calculating an actual value of an interval between the two linear patterns constituting a linear pattern pair on a basis of the captured image for each of (N−1) linear pattern pairs constituted by the N linear patterns included in each of the plurality of blocks, the linear pattern pair being a combination of the two linear patterns whose positions in the second direction are adjacent;
calculating a first error, a second error, and an average error for each of (N−2) linear patterns excluding linear patterns at both ends among the N linear patterns included in each of the plurality of blocks, the first error being a difference between the theoretical value and an actual value for a first linear pattern pair, the second error being a difference between the theoretical value and an actual value for a second linear pattern pair, the average error being an average of the first error and the second error, the first linear pattern pair being one of two linear pattern pairs including each linear pattern excluding the linear patterns at both ends among the N linear patterns, and the second linear pattern pair being another of the two linear pattern pairs;
setting, for each of the plurality of blocks, an actual position of a linear pattern in which a minimum average error is obtained by the calculating the first error, the second error, and the average error among the (N−2) linear patterns as a reference position;
calculating an ideal position at which each linear pattern is to be formed, on a basis of the reference position;
calculating a difference in the second direction between the ideal position and the actual position based on the captured image for each linear pattern; and
determining whether or not a nozzle corresponding to each linear pattern is a defective nozzle on a basis of the difference.

According to such a configuration, on the basis of the captured image of the print image of the test chart divided into the plurality of blocks in a direction in which the plurality of nozzles is arranged, for each linear pattern (excluding the linear patterns at both ends) included in each of the plurality of blocks, an average error representing how close the interval with two linear patterns each adjacent in position in a direction orthogonal to a direction in which the plurality of nozzles is arranged is to the theoretical value is calculated. Then, the actual position of the linear pattern from which the minimum average error is obtained is set as the reference position, and the ideal position of each linear pattern is calculated on the basis of the reference position. Therefore, unlike the conventional method, even if the nozzle corresponding to the linear pattern at the end portion of each block is a defective nozzle, the reference position in each block can be correctly obtained, so that the ideal position of each linear pattern can be correctly obtained. As a result, the difference (the difference in the direction orthogonal to the direction in which the plurality of nozzles is arranged) between the actual position and the ideal position of each linear pattern is accurately calculated, so that whether or not the nozzle corresponding to each linear pattern is a defective nozzle can be accurately determined. As above, regarding the printing apparatus, it is possible to detect a defective nozzle with higher accuracy than before. Therefore, since wasteful consumption of print media and ink caused by reprinting is suppressed, it is possible to contribute to the achievement of sustainable development targets (SDGs).

These and other objects, features, modes, and advantageous effects of the present invention will become more apparent from the following detailed description of the present invention with reference to the accompanying drawings.

### BRIEF DESCRIPTION OF THE DRAWINGS

FIG. 1 is a schematic diagram illustrating a configuration example of an inkjet printing apparatus in a first embodiment of the present invention;

FIG. 2 is a plan view illustrating a configuration example of a recording section in the first embodiment;

FIG. 3 is a diagram for describing an arrangement example of nozzles in the first embodiment;

FIG. 4 is a block diagram illustrating a hardware configuration of a print control device in the first embodiment;

FIG. 5 is a block diagram illustrating a schematic functional configuration of a control section realized by executing a print control program in the print control device in the first embodiment;

FIG. 6 is a diagram schematically illustrating an entire configuration of a test chart in the first embodiment;

FIG. 7 is a diagram schematically illustrating a part of the test chart in the first embodiment;

FIG. 8 is a diagram schematically illustrating a portion corresponding to an inspection range of one processing in the entire test chart in the first embodiment;

FIG. 9 is a diagram for describing an outline of detection of a defective nozzle in the first embodiment;

FIG. 10 is a diagram for describing an outline of detection of a defective nozzle in the first embodiment;

FIG. 11 is a block diagram illustrating a detailed configuration of a defective nozzle detection section in the first embodiment;

FIG. 12 is a flowchart illustrating a detailed procedure of processing of detecting the defective nozzle in the first embodiment;

FIG. 13 is a diagram for describing that each processing is performed on the basis of a gravity center position of linear patterns in the first embodiment;

FIG. 14 is a diagram for describing that each processing is performed on the basis of a gravity center position of the linear patterns in the first embodiment;

FIG. 15 is a diagram for describing a linear pattern pair in the first embodiment;

FIG. 16 is a diagram for describing calculation of an average error in the first embodiment;

FIG. 17 is a diagram for describing setting of a reference position in the first embodiment;

FIG. 18 is a diagram for describing calculation of an ideal position in the first embodiment;

FIG. 19 is a diagram for describing calculation of an average actual interval in a first modification of the first embodiment;

FIG. 20 is a diagram for describing calculation of an ideal position in the first modification of the first embodiment;

FIG. 21 is a diagram for describing setting of a reference position in a second modification of the first embodiment;

FIG. 22 is a diagram for describing an outline of a second embodiment of the present invention;

FIG. 23 is a diagram for describing a block in the second embodiment;

FIG. 24 is a diagram for describing a theoretical value of an interval between two linear patterns in the second embodiment;

FIG. 25 is a diagram for describing a linear pattern pair in the second embodiment;

FIG. 26 is a diagram for describing setting of a reference position in the second embodiment;

FIG. 27 is a diagram for describing calculation of an ideal position in the second embodiment;

FIG. 28 is a diagram for describing calculation of an average actual interval in a first modification of the second embodiment;

FIG. 29 is a diagram for describing calculation of an ideal position in the first modification of the second embodiment;

FIG. 30 is a diagram for describing setting of a reference position in a second modification of the second embodiment;

FIG. 31 is a diagram schematically illustrating an example of a part of a test chart in a conventional example;

FIG. 32 is a diagram for describing that an ideal position of each linear pattern cannot be correctly obtained in the conventional example; and

FIG. 33 is a diagram for describing that an ideal position of each linear pattern cannot be correctly obtained in the conventional example.

### DETAILED DESCRIPTION OF PREFERRED EMBODIMENTS

Hereinafter, embodiments of the present invention will be described with reference to the accompanying drawings.

### 1. First Embodiment

### <1.1 Configuration of Inkjet Printing Apparatus>

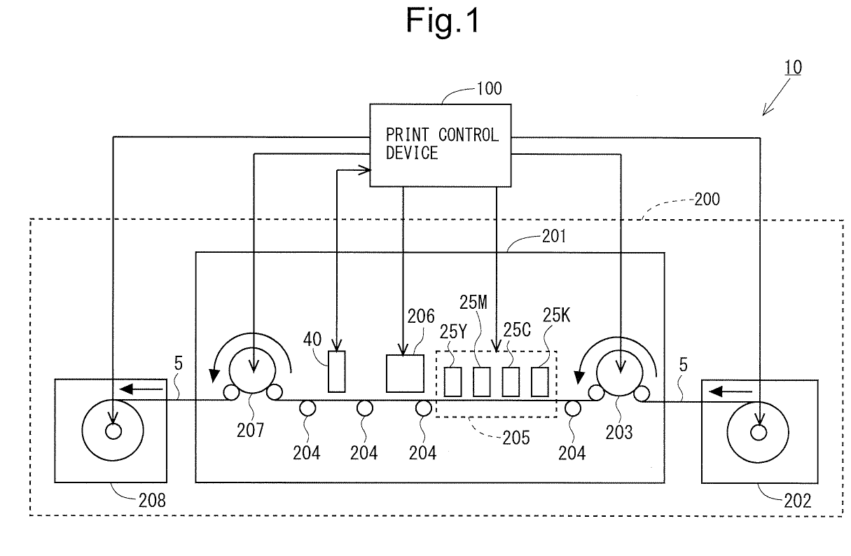

FIG. 1 is a schematic diagram illustrating a configuration example of an inkjet printing apparatus 10 in a first embodiment. The inkjet printing apparatus 10 includes a printing machine body 200 and a print control device 100 that controls an operation of the printing machine body 200. The inkjet printing apparatus 10 outputs, without using a printing plate, a print image on printing paper 5 as a print medium on the basis of print data that is data after rasterization processing sent via a network such as a LAN. Note that the present invention can also be applied to a case where a print medium (for example, a film) other than the printing paper is used.

The printing machine body 200 includes a paper feeding section 202 that supplies the printing paper (in this example, rolled printing paper) 5 to a printing mechanism 201, the printing mechanism 201 that performs printing on the printing paper 5, and a paper winding section 208 that winds the printing paper 5 after printing in a roll.

The printing mechanism 201 includes a first drive roller 203 for conveying the printing paper 5 to the inside, a plurality of support rollers 204 for conveying the printing paper 5 inside the printing mechanism 201, a recording section 205 that records a print image on the printing paper 5, a drying mechanism 206 that dries the printing paper 5 on which the print image is recorded, and a second drive roller 207 for outputting the printing paper 5 from the inside of the printing mechanism 201. The recording section 205 includes a K color head unit 25K that ejects K color (black) ink, a C color head unit 25C that ejects C color (cyan) ink, an M color head unit 25M that ejects M color (magenta) ink, and a Y color head unit 25Y that ejects Y color (yellow) ink. Furthermore, the printing mechanism 201 includes an inline scanner 40 as an imaging device that captures a print image recorded on the printing paper 5 by the recording section 205. A captured image (captured data) obtained by capturing the print image by the inline scanner 40 is sent to the print control device 100, and in the print control device 100, processing of detecting a defective nozzle is performed using the captured image. Note that, in the following description, in a case where the color of the ink ejected from the head unit is not distinguished, the head unit is denoted by reference sign 25.

### <1.2 Configuration of Recording Section>

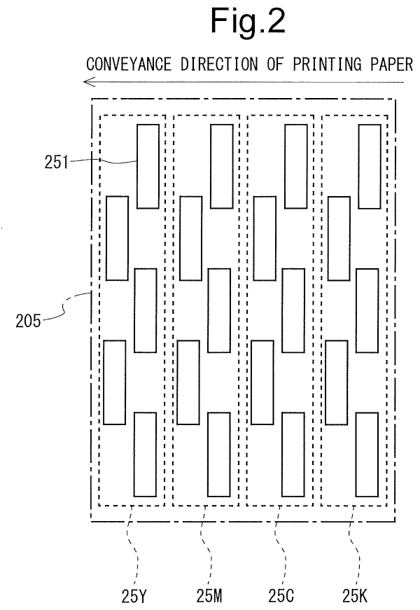

FIG. 2 is a plan view illustrating a configuration example of the recording section 205. As illustrated in FIG. 2, the recording section 205 includes the K color head unit 25K, the C color head unit 25C, the M color head unit 25M, and the Y color head unit 25Y arranged in a conveyance direction of the printing paper 5. Each head unit 25 includes a plurality of ink ejection heads (print heads) 251 arranged in a staggered manner. Each of the ink ejection heads 251 includes a large number of nozzles (not illustrated in FIG. 2) that eject ink. Each nozzle of the ink ejection head 251 included in the K color head unit 25K ejects K color ink, each nozzle of the ink ejection head 251 included in the C color head unit 25C ejects C color ink, each nozzle of the ink ejection head 251 included in the M color head unit 25M ejects M color ink, and each nozzle of the ink ejection head 251 included in the Y color head unit 25Y ejects Y color ink.

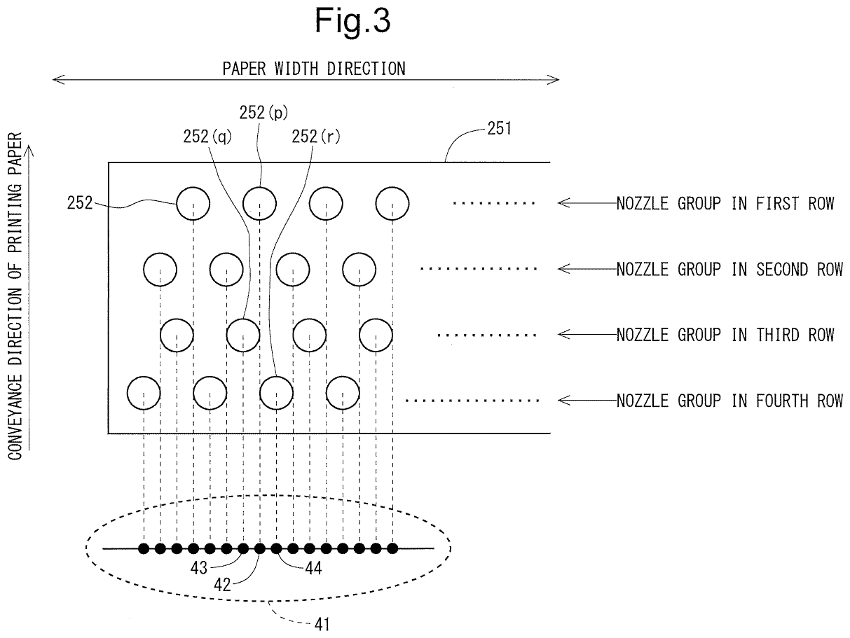

FIG. 3 is a diagram for describing an arrangement of nozzles 252 in the ink ejection head 251. Typically, the ink ejection head 251 includes a plurality of rows of nozzle groups each including a plurality of nozzles 252 arranged side by side in a paper width direction. In the example illustrated in FIG. 3, four rows of nozzle groups are included in the ink ejection head 251. Note that the paper width direction corresponds to a first direction, and the conveyance direction of the printing paper 5 corresponds to a second direction. In a portion denoted by reference sign 41 in FIG. 3, landing positions (landing positions in the paper width direction), on the printing paper 5, of the ink ejected from each nozzle 252 are schematically illustrated. The plurality of nozzles 252 in the ink ejection head 251 are arranged so that the landing positions of the ink ejected from the nozzles 252 included in the nozzle group in the first row, the landing positions of the ink ejected from the nozzles 252 included in the nozzle group in the second row, the landing positions of the ink ejected from the nozzles 252 included in the nozzle group in the third row, and the landing positions of the ink ejected from the nozzles 252 included in the nozzle group in the fourth row are different positions. For example, the landing position of the ink ejected from each nozzle 252 included in the nozzle group in the first row is a position between the landing position of the ink ejected from the nozzle 252 included in the nozzle group in the third row and the landing position of the ink ejected from the nozzle 252 included in the nozzle group in the fourth row. In the example illustrated in FIG. 3, a landing position 42 of the ink ejected from the nozzle denoted by reference sign 252(p) is a position between a landing position 43 of the ink ejected from the nozzle denoted by reference sign 252(q) and a landing position 44 of the ink ejected from the nozzle denoted by reference sign 252(r). Note that the arrangement illustrated in FIG. 3 is an example, and the specific arrangement of the plurality of nozzles 252 is not particularly limited as long as the plurality of nozzles 252 are arranged in the paper width direction.

In the present embodiment, a test chart or the like is printed by ejecting ink from the fixed ink ejection head 251 while moving the printing paper 5. That is, in the present embodiment, the inkjet printing apparatus 10 in one-pass system is adopted. However, the present invention can also be applied to a case where a shuttle type inkjet printing apparatus is adopted. In the shuttle type inkjet printing apparatus, after an ink ejection head moves from one end side of a print medium such as printing paper to the other end side thereof while ejecting ink (that is, after the movement in a main scanning direction), the ink ejection head moves by a predetermined distance in a sub-scanning direction (direction orthogonal to the main scanning direction). Thereafter, the ink ejection head moves from the other end side of the print medium to one end side thereof while ejecting ink. Then, the ink ejection head moves again by a predetermined distance in the sub-scanning direction. In this manner, in the shuttle type inkjet printing apparatus, the ink ejection head moves in the sub-scanning direction to form a print image on the entire print medium from the upper part to the lower part. From the above, the present invention can be applied to any inkjet printing apparatus that performs printing while relatively moving the positional relationship between the ink ejection head and the print medium in a direction orthogonal to the direction (paper width direction) in which the plurality of nozzles are arranged.

### <1.3 Hardware Configuration of Print Control Device>

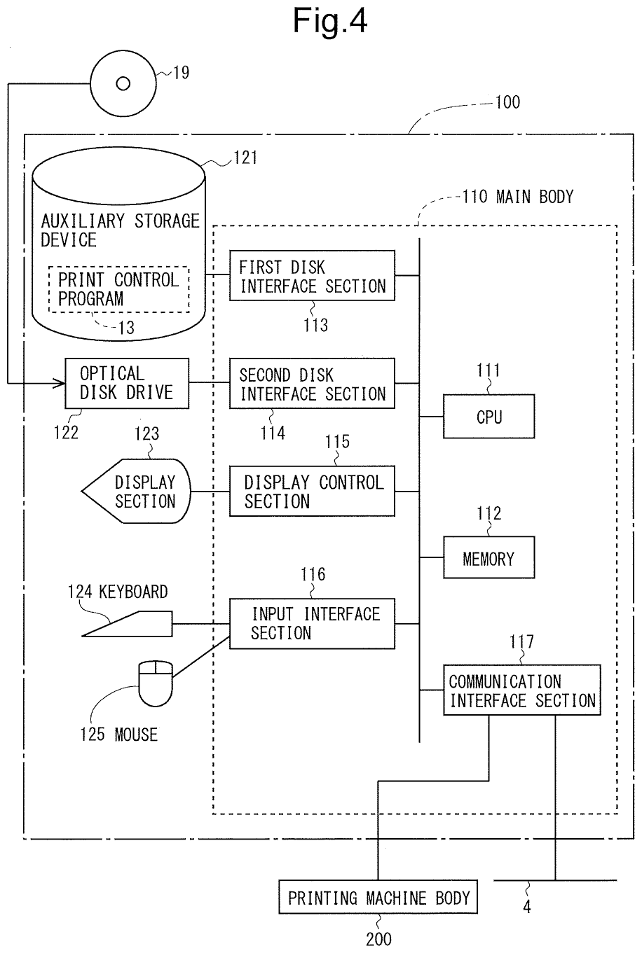

FIG. 4 is a block diagram illustrating a hardware configuration of the print control device 100. As illustrated in FIG. 4, the print control device 100 includes a main body 110, an auxiliary storage device 121, an optical disk drive 122, a display section 123, a keyboard 124, a mouse 125, and the like. The main body 110 includes a CPU 111, a memory 112, a first disk interface section 113, a second disk interface section 114, a display control section 115, an input interface section 116, and a communication interface section 117. The CPU 111, the memory 112, the first disk interface section 113, the second disk interface section 114, the display control section 115, the input interface section 116, and the communication interface section 117 are connected to each other via a system bus. The auxiliary storage device 121 is connected to the first disk interface section 113. The optical disk drive 122 is connected to the second disk interface section 114. The display section (display device) 123 is connected to the display control section 115. The keyboard 124 and the mouse 125 are connected to the input interface section 116. The printing machine body 200 is connected to the communication interface section 117 via a communication cable. Furthermore, the communication interface section 117 is connected to the LAN 4. The auxiliary storage device 121 is a magnetic disk device or the like. An optical disk 19 as a computer-readable recording medium such as a CD-ROM or a DVD-ROM is inserted into the optical disk drive 122. The display section 123 is a liquid crystal display or the like. The display section 123 is used to display information desired by an operator. The keyboard 124 and the mouse 125 are used by an operator to input instructions to the print control device 100.

The auxiliary storage device 121 stores a print control program (program for controlling execution of printing processing by the printing machine body 200) 13. The print control program 13 in the present embodiment includes a program for detecting a defective nozzle as a subprogram. The CPU 111 implements various functions of the print control device 100 by reading the print control program 13 stored in the auxiliary storage device 121 into the memory 112 and executing the program. The memory 112 includes a random access memory (RAM) and a read only memory (ROM). The memory 112 functions as a work area for the CPU 111 to execute the print control program 13 stored in the auxiliary storage device 121. Note that the print control program 13 is provided by being stored in the computer-readable recording medium (non-transitory recording medium). That is, for example, the user purchases the optical disk 19 as a recording medium of the print control program 13, inserts the optical disk into the optical disk drive 122, reads the print control program 13 from the optical disk 19, and installs the print control program in the auxiliary storage device 121.

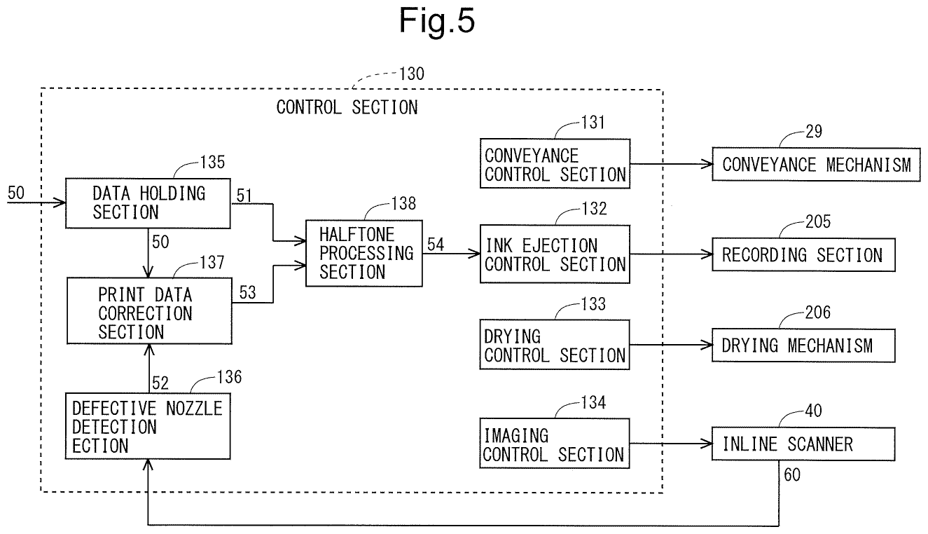

Note that, although only one CPU 111 is provided as a processor in the print control device 100 in the example illustrated in FIG. 4, the present invention is not limited thereto. A configuration using a plurality of processors such as a configuration using a plurality of CPUs can also be adopted. As the processor, in addition to the CPU 111, a micro processing unit (MPU), a graphics processing unit (GPU), a digital signal processor (DSP), or the like can also be adopted. Furthermore, a plurality of types of processors can be used in combination. For example, regarding the components (see FIG. 5) inside a control section 130 to be described later, some components and the remaining components may be realized by different processors. Moreover, a configuration including a field-programmable gate array (FPGA) or an application specific integrated circuit (ASIC) can also be adopted.

### <1.4 Functional Configuration>

FIG. 5 is a block diagram illustrating a schematic functional configuration of the control section 130 realized by the print control device 100 executing the print control program 13. The control section 130 includes a conveyance control section 131, an ink ejection control section 132, a drying control section 133, an imaging control section 134, a data holding section 135, a defective nozzle detection section 136, a print data correction section 137, and a halftone processing section 138.

The conveyance control section 131 controls the speed (conveyance speed) at which a conveyance mechanism 29 conveys the printing paper 5. Note that the conveyance mechanism 29 is realized by the paper feeding section 202, the first drive roller 203, the plurality of support rollers 204, the second drive roller 207, and the paper winding section 208 (see FIG. 1). The drying control section 133 controls a temperature (drying temperature) when the drying mechanism 206 dries the printing paper 5 after printing. The imaging control section 134 controls the imaging timing of the print image by the inline scanner 40.

The data holding section 135 temporarily holds print data 50 sent via the network. The data holding section 135 also holds test chart data 51 representing a test chart used in processing of detecting a defective nozzle. Note that the test chart will be described later in detail.

The defective nozzle detection section 136 detects a defective nozzle on the basis of a captured image (captured data) 60 obtained by capturing the print image of the test chart with the inline scanner 40. Then, defective nozzle information 52 for specifying a defective nozzle is outputted from the defective nozzle detection section 136. Note that the defective nozzle detection section 136 will be described later in detail.

On the basis of the defective nozzle information 52, the print data correction section 137 corrects the print data 50 being held in the data holding section 135 so that the ejection failure of the nozzle is compensated. In this regard, for example, the print data 50 is corrected so that an ejection amount of ink from a nozzle around a nozzle determined to be the defective nozzle increases. Then, the print data correction section 137 outputs corrected print data 53.

The halftone processing section 138 generates halftone image data 54 including information indicating a dot size of ink corresponding to each pixel by performing halftone processing on data to be printed. As the dot size of the ink, for example, three-stage sizes (L size, M size, and S size) are prepared. In the present embodiment, the halftone processing is performed on the test chart data 51 and the corrected print data 53 outputted from the print data correction section 137. Note that a specific technique of the halftone processing is not particularly limited, and for example, a known technique such as an error diffusion method or a dither method can be adopted.

The ink ejection control section 132 controls the ejection of ink from each nozzle 252 included in the four head units 25K, 25C, 25M, and 25Y constituting the recording section 205 on the basis of the halftone image data 54 generated by the halftone processing section 138. For example, the ink ejection timing and the ink ejection amount are controlled.

### <1.5 Test Chart>

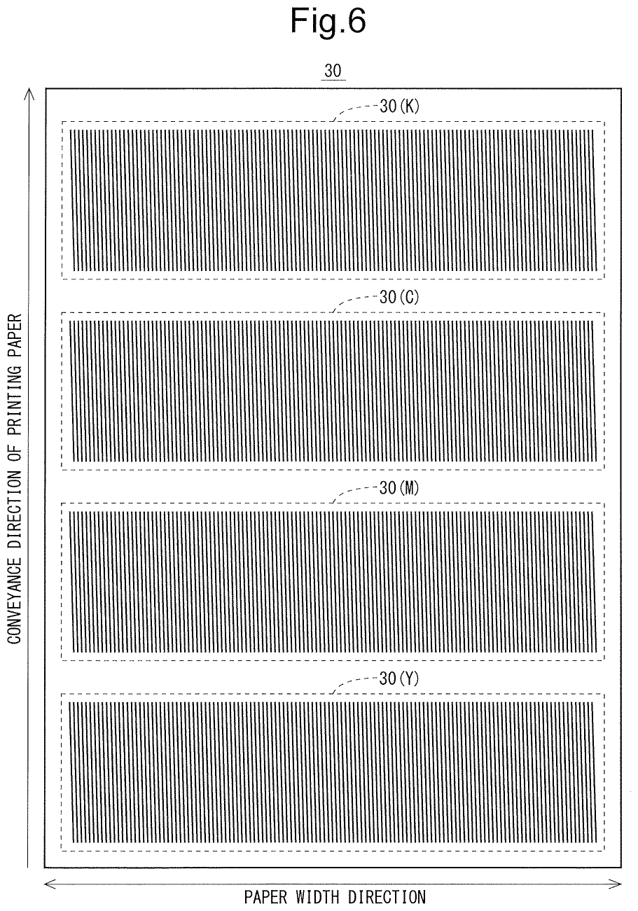

Next, a test chart used for processing of detecting a defective nozzle will be described. FIG. 6 is a diagram schematically illustrating an entire configuration of a test chart 30. The test chart 30 includes a K color chart 30(K) formed by ejecting ink from the nozzles 252 included in the K color head unit 25K, a C color chart 30(C) formed by ejecting ink from the nozzles 252 included in the C color head unit 25C, an M color chart 30(M) formed by ejecting ink from the nozzles 252 included in the M color head unit 25M, and a Y color chart 30(Y) formed by ejecting ink from the nozzles 252 included in the Y color head unit 25Y. The K color chart 30(K), the C color chart 30(C), the M color chart 30(M), and the Y color chart 30(Y) are arranged side by side in the conveyance direction of the printing paper 5.

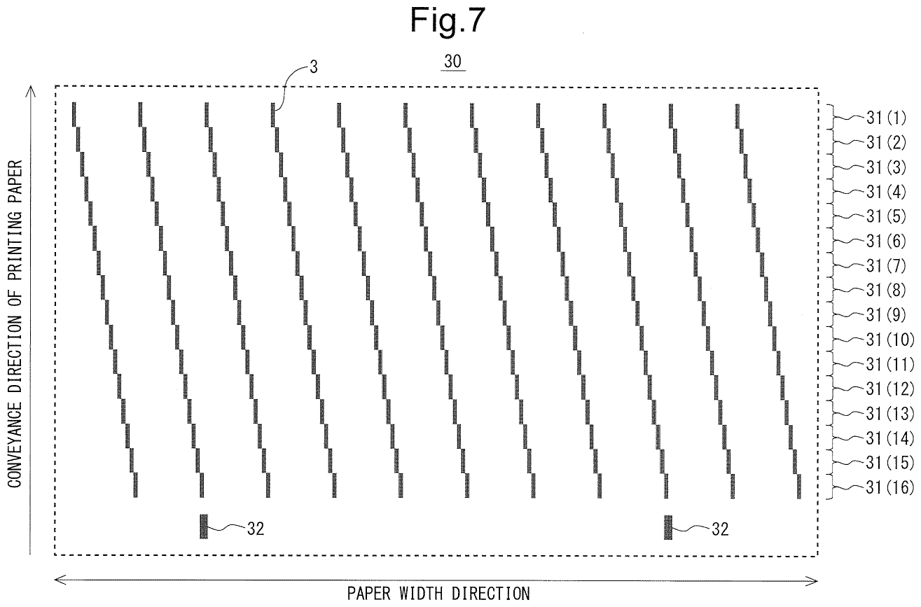

FIG. 7 is a diagram schematically illustrating a part of the test chart 30. The test chart 30 is configured by a stepwise regular pattern including a large number of linear patterns 3 extending in the conveyance direction of the printing paper 5. Each of the linear patterns 3 is formed by ejecting ink from one nozzle 252 a plurality of times (for example, 52 times) in succession. Furthermore, the test chart 30 includes a plurality of nozzle number specifying marks 32. When the range between the two adjacent nozzle number specifying marks 32 is set as the inspection range of one processing at the time of the processing of detecting a defective nozzle, the number of nozzles 252 corresponding to the inspection range is accurately specified, so that the detection accuracy of the defective nozzle is improved. In the example illustrated in FIG. 7, the test chart 30 is divided into 16 blocks 31(1) to 31(16), and the plurality of linear patterns 3 is arranged at equal intervals in the paper width direction in each block 31. Note that the linear pattern may be denoted by a reference sign other than 3 for convenience of description. Note that each of the plurality of nozzle number specifying marks 32 is formed using a plurality of (for example, 16) nozzles 252 adjacent in the paper width direction. Since it is extremely rare that a plurality of (for example, 16) nozzles 252 adjacent in the paper width direction simultaneously become malfunction, the nozzle number specifying mark 32 is reliably formed.

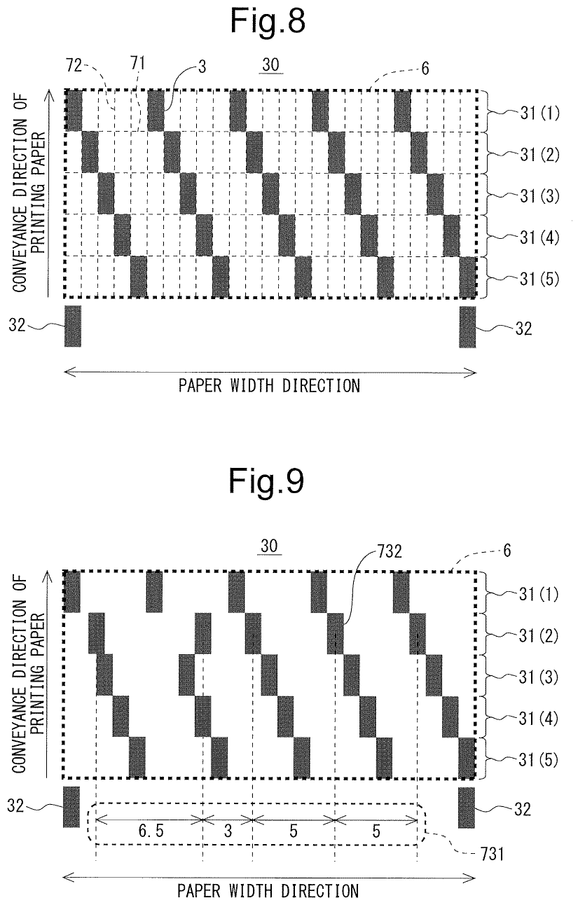

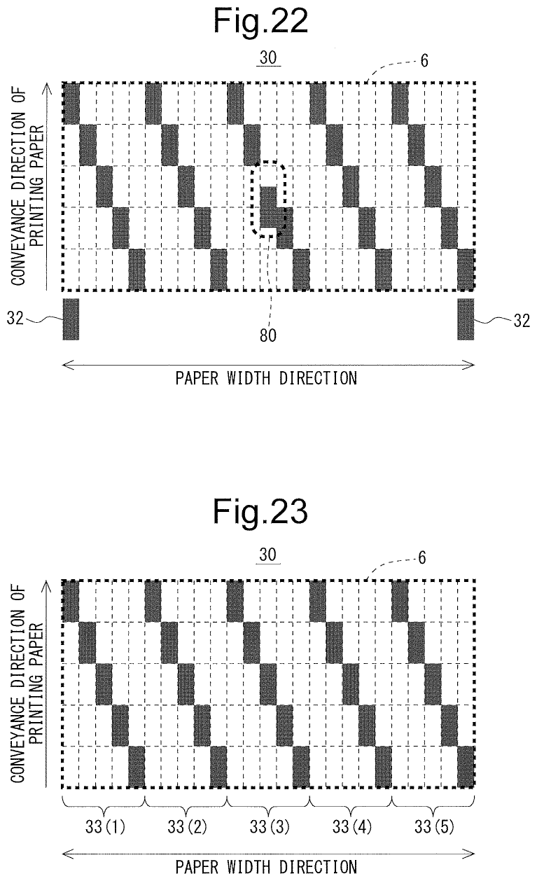

In the following description, in order to simplify the description, unless otherwise specified, it is assumed that a portion corresponding to an inspection range (range between the two nozzle number specifying marks 32) 6 for one processing in the entire test chart 30 is as illustrated in FIG. 8. The test chart 30 illustrated in FIG. 8 is divided into five blocks 31(1) to 31(5) each including five linear patterns 3. The length of the inspection range 6 in the paper width direction is 25 (Again, the unit of length is omitted). Note that a horizontal dotted line denoted by reference sign 71 in FIG. 8 and a vertical dotted line denoted by reference sign 72 in FIG. 8 are dotted lines illustrated for description, and these dotted lines are not actually printed together with the linear pattern 3 (the same applies to FIGS. 22 and 23).

Here, the test chart 30 in a portion corresponding to the inspection range 6 will be generalized. Assuming that K is an integer of 3 or more, the test chart 30 includes a plurality of linear patterns 3 to be formed by ejecting ink from the plurality of nozzles 252, and is divided into K blocks in the conveyance direction of the printing paper 5. Assuming that N is an integer of 4 or more, each of the K blocks includes N linear patterns 3 to be formed such that an interval between two linear patterns 3 adjacent in the paper width direction is constant. The test chart 30 is configured such that the N linear patterns 3 included in the Pth block are each formed at a position shifted by a certain distance in the paper width direction from the N linear patterns 3 included in the (P−1)th block, where P is an integer of 2 to K.

### <1.6 Defective Nozzle Detection Method>

Hereinafter, a method of detecting a defective nozzle will be described. In the present embodiment, the detection of the defective nozzle is performed on the basis of the position (X-coordinate value), in the paper width direction, of the linear pattern 3 in the captured image 60. Note that, in a second embodiment described later, the detection of the defective nozzle is performed on the basis of the position (Y-coordinate value), in the conveyance direction of the printing paper 5, of the linear pattern 3 in the captured image 60.

### <1.6.1 Outline>

In the present embodiment, the interval between the two linear patterns 3 is obtained for all combinations of the two linear patterns 3 adjacent in the paper width direction on the basis of the captured image 60 of the print image of the test chart 30. For the linear patterns 3 other than the linear patterns 3 located at both ends in each block 31, the value of the interval with the left adjacent linear pattern 3 (hereinafter, the value is referred to as a “first interval value”) and the value of the interval with the right adjacent linear pattern 3 (hereinafter, the value is referred to as a “second interval value”) are obtained. Then, the position (position in the captured image 60) of the linear pattern 3 where a minimum average error (the average error is the average of a “difference between the first interval value and the theoretical value (theoretical value of an interval between two linear patterns 3)” and a “difference between the second interval value and the theoretical value”) is obtained in each block 31 is set as the reference position. The average of the first interval value and the second interval value for the linear pattern 3 corresponding to the reference position set in this manner is obtained as the “average actual interval”, and the ideal position of each linear pattern 3 is obtained by adding or subtracting an integral multiple of the average actual interval to or from the coordinate value (X coordinate value) of the reference position. By comparing the ideal position thus obtained with the actual position in the captured image 60, it is determined whether or not the nozzle corresponding to each linear pattern 3 is a defective nozzle.

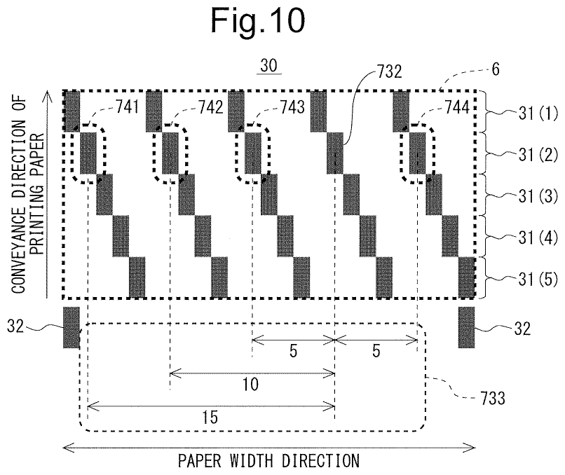

Assuming that the captured image 60 of the print image of the test chart 30 is as illustrated in FIG. 9, attention is paid to block 31(2) in FIG. 9. An interval between the two linear patterns 3 in the block 31(2) is indicated in a dotted line portion denoted by reference sign 731. Since the length of the inspection range 6 in the paper width direction is 25 and the number of linear patterns 3 per block is 5, the theoretical value of the interval between the two linear patterns 3 is 5. Therefore, in this case, the linear pattern 3 from which the minimum average error is obtained among the linear patterns 3 included in the block 31(2) is a linear pattern denoted by reference sign 732. Thus, the position of the linear pattern 732 is set as the reference position. Then, since the above-described average actual interval is 5, as illustrated in FIG. 10, the ideal position (see the dotted line portion denoted by reference signs 741 to 744) of each of the linear patterns 3 other than the linear pattern 732 is obtained by adding or subtracting an integral multiple of 5 to or from the X coordinate of the reference position (see the dotted line portion denoted by reference sign 733).

### <1.6.2 Details of Detection of Defective Nozzle>

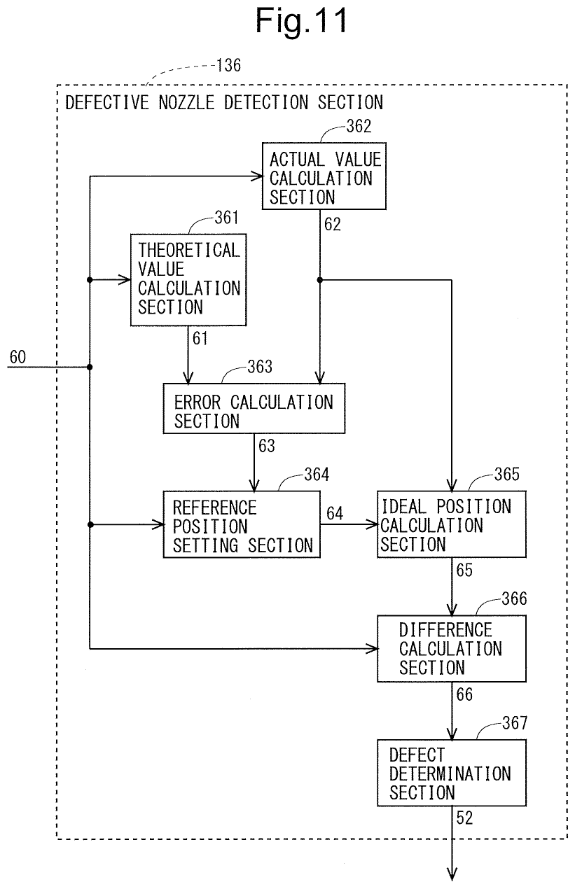

FIG. 11 is a block diagram illustrating a detailed configuration of the defective nozzle detection section 136. As illustrated in FIG. 11, the defective nozzle detection section 136 includes a theoretical value calculation section 361, an actual value calculation section 362, an error calculation section 363, a reference position setting section 364, an ideal position calculation section 365, a difference calculation section 366, and a defect determination section 367.

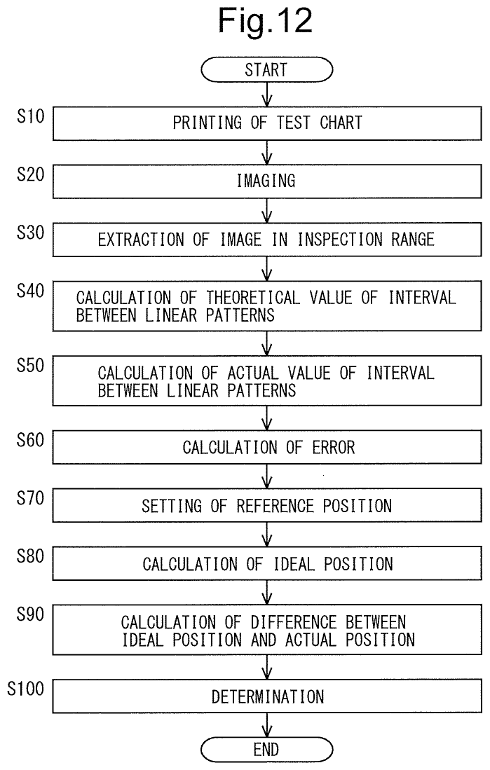

FIG. 12 is a flowchart illustrating a detailed procedure of processing of detecting a defective nozzle. First, printing of the test chart 30 is performed (step S10). Specifically, the halftone image data 54 is generated by performing the halftone processing on the test chart data 51 held in the data holding section 135, and a print image of the test chart 30 is formed on the printing paper 5 by the ink ejection control section 132 controlling the ejection amount of ink from each nozzle 252 on the basis of the halftone image data 54 (see FIG. 5).

After the test chart 30 is printed, the print image of the test chart 30 is captured by the inline scanner 40 (step S20). The captured image (captured data) 60 thus obtained is provided to the control section 130.

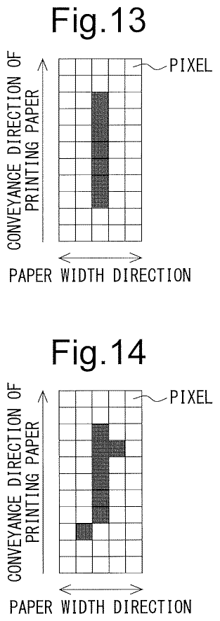

Meanwhile, the captured image 60 obtained by the inline scanner 40 capturing the print image of the test chart 30 is multi-gradation image data, but the processing after step S40 is performed on binary image data. Therefore, processing of binarizing the multi-gradation image data is performed (not illustrated in the flowchart). Furthermore, the linear pattern 3 in the captured image 60 is not necessarily a straight line image as illustrated in FIG. 13. The linear pattern 3 in the captured image 60 may be an image as illustrated in FIG. 14, for example. Therefore, in the processing in and after step S40, the calculation or the like regarding the position is performed on the basis of the gravity center position in the paper width direction of each linear pattern 3 in the captured image 60. However, if the position is clearly specified, calculation or the like regarding the position may be performed on the basis of a position other than the gravity center position. For example, calculation or the like regarding the position may be performed on the basis of left end (or right end) position coordinates in the paper width direction of the detected linear pattern 3.

After the captured image 60 after binarization is obtained, the image in the inspection range 6 is extracted (step S30). In this regard, as described above, the test chart 30 includes the plurality of nozzle number specifying marks 32. In step S30, an image in a range between the two nozzle number specifying marks 32 is extracted from the captured image 60 as the image in the inspection range 6. Since the image in the inspection range 6 is thus extracted in step S30, the processing in and after step S40 is performed for each inspection range 6. Note that, hereinafter, the image extracted in step S30 is also referred to as the “captured image 60”.

Thereafter, the theoretical value calculation section 361 calculates a theoretical value 61 of the interval between the two linear patterns 3 adjacent in the paper width direction (step S40). Specifically, in step S40, the theoretical value 61 is calculated on the basis of the distance between the gravity center position in the paper width direction of the nozzle number specifying mark 32 corresponding to the left end of the inspection range 6 (hereinafter, the mark is referred to as a “first mark”) and the gravity center position in the paper width direction of the nozzle number specifying mark 32 corresponding to the right end of the inspection range 6 (hereinafter, the mark is referred to as a “second mark”), the number of linear patterns 3 to be included in the image (captured image 60) extracted in step S30, and the number of blocks 31. Note that the gravity center position of the first mark corresponds to a first predetermined position, and the gravity center position of the second mark corresponds to a second predetermined position. In the example of the test chart 30 illustrated in FIG. 8, the number of linear patterns 3 to be included in the image (captured image 60) extracted in step S30 is 25, and the number of blocks 31 is 5. Therefore, the number of linear patterns 3 to be included in each block 31 is 5. Furthermore, the distance between the first mark and the second mark is 25. Thus, the theoretical value 61 is calculated to be 5 by dividing 25 by 5.

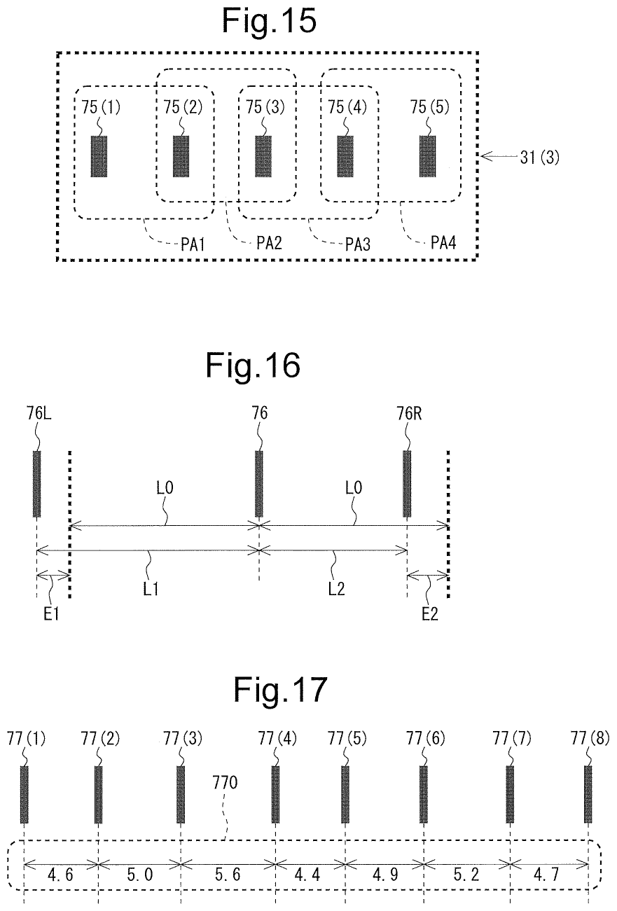

Next, the actual value calculation section 362 calculates an actual value (value in the captured image 60) 62 of the interval between the two linear patterns 3 for all combinations of the two linear patterns 3 adjacent in the paper width direction on the basis of the captured image 60 (step S50). In this regard, when two linear patterns 3 adjacent in the paper width direction are defined as a “linear pattern pair”, each block 31 includes four linear pattern pairs. For example, when reference signs 75(1) to 75(5) are assigned to the five linear patterns 3 included in the block 31(3) as illustrated in FIG. 15, the block 31(3) includes a linear pattern pair PA1 configured by a linear pattern 75(1) and a linear pattern 75(2), a linear pattern pair PA2 configured by a linear pattern 75(2) and a linear pattern 75(3), a linear pattern pair PA3 configured by a linear pattern 75(3) and a linear pattern 75(4), and a linear pattern pair PA4 configured by a linear pattern 75(4) and a linear pattern 75(5). In this way, four linear pattern pairs are configured by the five linear patterns 3. In step S50, the actual value 62 of the interval between the two linear patterns 3 constituting such a linear pattern pair is obtained. From the above, in step S50, with the combination of the two linear patterns 3 adjacent in the paper width direction regarded as the linear pattern pair, for each of the (N−1) linear pattern pairs (in the example illustrated in FIG. 8, four linear pattern pairs) configured by the N linear patterns 3 (in the example illustrated in FIG. 8, five linear patterns) included in each of the plurality of blocks 31, the actual value 62 of the interval between the two linear patterns 3 constituting the linear pattern pair is calculated on the basis of the captured image 60.

Next, the error calculation section 363 calculates the above-described average error 63 for each linear pattern 3 except for the linear patterns 3 located at both ends of each block 31 (step S60). In this regard, the linear patterns 3 other than the linear patterns 3 located at both ends of each block 31 form a linear pattern pair with the left adjacent linear pattern 3, and also form a linear pattern pair with the right adjacent linear pattern 3. Here, one of the two linear pattern pairs configured as described above is defined as a “first linear pattern pair”, and the other is defined as a “second linear pattern pair”. In step S60, for each linear pattern 3 excluding the linear patterns 3 located at both ends of each block 31, a difference between the theoretical value 61 calculated in step S40 and the actual value 62 calculated in step S50 for the first linear pattern pair (the actual value 62 corresponds to the above-described first interval value) is calculated as a first error, and a difference between the theoretical value 61 calculated in step S40 and the actual value 62 calculated in step S50 for the second linear pattern pair (the actual value 62 corresponds to the above-described second interval value) is calculated as a second error. Then, the average of the first error and the second error is calculated as the average error 63. From the above, in step S60, for each of the (N−2) linear patterns (in the example illustrated in FIG. 8, three linear patterns) 3 excluding the linear patterns 3 at both ends among the N linear patterns (in the example illustrated in FIG. 8, five linear patterns) 3 included in each of the plurality of blocks 31, the first error that is the difference between the theoretical value 61 and the actual value 62 for the first linear pattern pair, the second error that is the difference between the theoretical value 61 and the actual value 62 for the second linear pattern pair, and the average error 63 that is the average of the first error and the second error are calculated.

The calculation of the average error 63 will be further described with reference to FIG. 16. In FIG. 16, a focused linear pattern is denoted by reference sign 76, a linear pattern constituting a first linear pattern pair with the linear pattern 76 is denoted by reference sign 76L, and a linear pattern constituting a second linear pattern pair with the linear pattern 76 is denoted by reference sign 76R. When the theoretical value 61 calculated in step S40 is the value of the distance represented by the arrow denoted by the reference sign L0, a difference (first error E1) between the actual value L1 for the first linear pattern pair (the interval between the linear pattern 76 and the linear pattern 76L) and the theoretical value L0 and a difference (second error E2) between the actual value L2 for the second linear pattern pair (the interval between the linear pattern 76 and the linear pattern 76R) and the theoretical value L0 are calculated, and the average of the first error E1 and the second error E2 is further calculated as the average error 63.

After the average error 63 is calculated, the reference position setting section 364 sets the actual position of the linear pattern 3 where the minimum average error 63 is obtained as a reference position 64 for each block 31 (step S70). Specifically, in step S70, for each of the plurality of blocks 31, the actual position (position in the captured image 60) of the linear pattern 3 for which the minimum average error 63 has been obtained in step S60 described above among the (N−2) linear patterns (in the example illustrated in FIG. 8, three linear patterns) 3 is set as the reference position 64. For example, it is assumed that a certain block 31 includes eight linear patterns 77(1) to 77(8) as illustrated in FIG. 17. An actual value 62 of the interval between the two linear patterns 3 adjacent in the paper width direction is written in a dotted line portion denoted by reference sign 770. In this example, in step S60, the average error 63 is calculated for each of the six linear patterns 77(2) to 77(7). When the theoretical value 61 calculated in step S40 is 5, the linear pattern 77(6) obtains the minimum average error 63 among the linear patterns 77(2) to 77(7). Therefore, the actual position of the linear pattern 77(6) is set to the reference position 64.

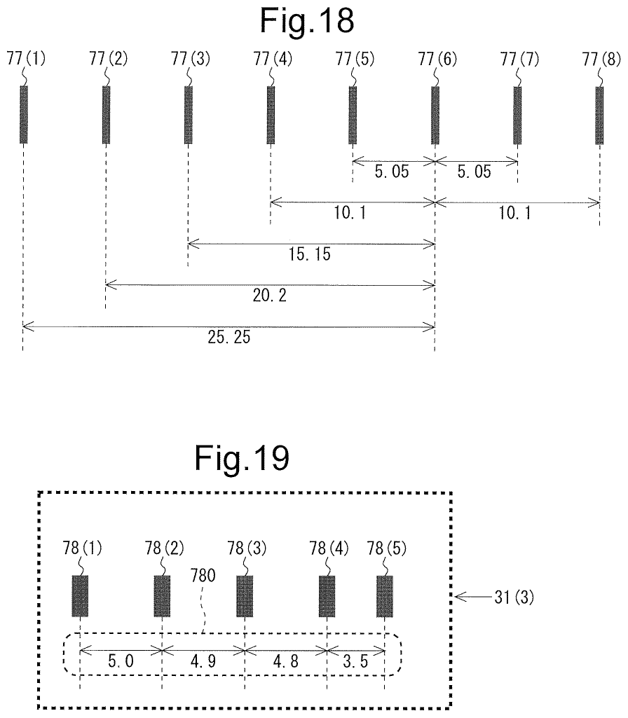

After setting the reference position 64, the ideal position calculation section 365 calculates the ideal position 65, which is the position where each linear pattern 3 is to be formed, on the basis of the reference position 64 (step S80). Specifically, when two linear patterns adjacent in the paper width direction to the linear pattern 3 corresponding to the reference position 64 are defined as a first adjacent linear pattern and a second adjacent linear pattern, in step S80, an average of an actual value 62 of the interval between the linear pattern 3 corresponding to the reference position 64 and the first adjacent linear pattern (the actual value corresponds to the first interval value described above) and an actual value 62 of the interval between the linear pattern 3 corresponding to the reference position 64 and the second adjacent linear pattern (the actual value corresponds to the second interval value described above) is calculated as an average actual interval, and the ideal position 65 is calculated assuming that the interval between the two linear patterns 3 constituting each linear pattern pair is the average actual interval. In this regard, in the example illustrated in FIG. 17, the linear pattern 77(6) is a linear pattern corresponding to the reference position 64, the linear pattern 77(5) is a first adjacent linear pattern, and the linear pattern 77(7) is a second adjacent linear pattern. The actual value 62 of the interval between the linear pattern 77(6) corresponding to the reference position 64 and the first adjacent linear pattern 77(5) is 4.9, and the actual value 62 of the interval between the linear pattern 77(6) corresponding to the reference position 64 and the second adjacent linear pattern 77(7) is 5.2. Therefore, the average actual interval is 5.05. In this case, as illustrated in FIG. 18, by adding or subtracting an integral multiple of 5.05, which is the average actual interval, to or from the X coordinate value of the reference position 64 (actual position of the linear pattern 77(6)), the ideal position 65 of each of the linear patterns 77(1) to 77(5) and 77(7) to 77(8) other than the linear pattern 77(6) corresponding to the reference position 64 is calculated.

Next, the difference calculation section 366 calculates a difference 66 in the paper width direction between the ideal position 65 calculated in step S80 and the actual position based on the captured image 60 for each linear pattern 3 (step S90). Finally, the defect determination section 367 determines whether or not the nozzle corresponding to each linear pattern 3 is a defective nozzle on the basis of the difference 66 calculated in step S90 (step S100). Thus, the processing of detecting a defective nozzle ends.

Note that, in the present embodiment, printing a test chart is realized by step S10, acquiring a captured image is realized by step S20, extracting an image is realized by step S30, calculating a theoretical value is realized by step S40, calculating an actual value is realized by step S50, calculating a first error, a second error, and an average error is realized by step S60, setting a reference position is realized by step S70, calculating an ideal position is realized by step S80, calculating a difference is realized by step S90, and determining whether or not a nozzle corresponding to each linear pattern is a defective nozzle is realized by step S100.

### <1.7 Effects>

According to the present embodiment, on the basis of the captured image 60 of the print image of the test chart 30 divided into the five blocks 31(1) to 31(5) in the conveyance direction of the printing paper 5 (direction orthogonal to the direction in which the plurality of nozzles 252 is arranged), for each linear pattern 3 (excluding the linear patterns 3 at both ends) included in each of the five blocks 31(1) to 31(5), the average error 63 representing how close the interval with two linear patterns 3 each adjacent in the paper width direction is to the theoretical value 61 is calculated. Then, the actual position of the linear pattern 3 where the minimum average error 63 is obtained is set as the reference position 64, and the ideal position 65 of each linear pattern 3 is calculated on the basis of the reference position 64. Therefore, unlike the conventional method, even if the nozzle 252 corresponding to the linear pattern 3 at the end portion of each block 31 is a defective nozzle, the reference position 64 in each block 31 can be correctly obtained, so that the ideal position 65 of each linear pattern 3 can be correctly obtained. As a result, the difference (difference in the paper width direction) 66 between the actual position of each linear pattern 3 and the ideal position 65 is accurately calculated, so that whether or not the nozzle corresponding to each linear pattern 3 is a defective nozzle can be accurately determined. As above, according to the present embodiment, regarding the inkjet printing apparatus 10, a defective nozzle can be detected with higher accuracy than before. Therefore, since wasteful consumption of the printing paper 5 and ink caused by reprinting is suppressed, it is possible to contribute to the achievement of sustainable development targets (SDGs).

### <1.8 Modifications>

### <1.8.1 First Modification>

In the first embodiment, the ideal position 65 of each linear pattern 3 is calculated assuming that the interval between the two linear patterns 3 constituting each linear pattern pair is the average of the “interval between the linear pattern 3 corresponding to the reference position 64 and the first adjacent linear pattern” and the “interval between the linear pattern 3 corresponding to the reference position 64 and the second adjacent linear pattern”. On the other hand, in the present modification, in step S80 in FIG. 12, the average of the actual values 62 for the linear pattern pairs in which the difference between the actual value 62 calculated in step S50 and the theoretical value 61 calculated in step S40 is less than or equal to a predetermined threshold among the (N−1) linear pattern pairs (in the example illustrated in FIG. 8, four linear pattern pairs) is calculated as the average actual interval for each of the plurality of blocks 31, and the ideal position 65 of each linear pattern 3 is calculated assuming that the interval between the two linear patterns 3 constituting each linear pattern pair is the average actual interval.

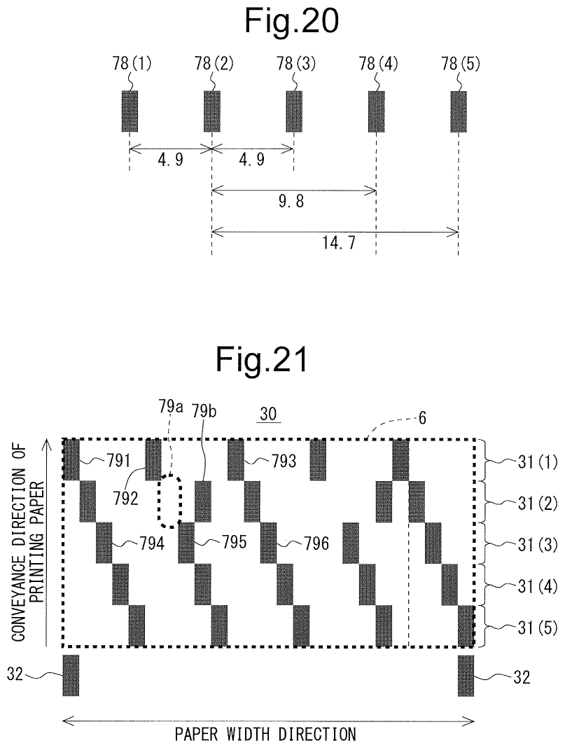

For example, it is assumed that the block 31(3) includes five linear patterns 78(1) to 78(5) as illustrated in FIG. 19. An actual value 62 of the interval between two linear patterns adjacent in the paper width direction is described in a dotted line portion denoted by reference sign 780. Note that the position of the linear pattern 78(2) is the reference position 64. Here, it is assumed that a threshold for comparing with the difference between the actual value 62 and the theoretical value 61 is set to 0.5. In this case, the difference is larger than the threshold for the linear pattern pair configured by the linear pattern 78(4) and the linear pattern 78(5), and the difference is less than or equal to the threshold for other linear pattern pairs. Therefore, the average actual interval in this example is 4.9 which is an average of 5.0 which is the actual value 62 for the linear pattern pair configured by the linear pattern 78(1) and the linear pattern 78(2), 4.9 which is the actual value 62 for the linear pattern pair configured by the linear pattern 78(2) and the linear pattern 78(3), and 4.8 which is the actual value 62 for the linear pattern pair configured by the linear pattern 78(3) and the linear pattern 78(4). Then, as illustrated in FIG. 20, by adding or subtracting an integral multiple of 4.9, which is the average actual interval, to or from the X coordinate value of the reference position 64 (actual position of the linear pattern 78(2)), the ideal position 65 of each of the linear patterns 78(1) and 78(3) to 78(5) other than the linear pattern 78(2) corresponding to the reference position 64 is calculated.

According to the present modification, the average of the actual values 62 of the intervals between the two linear patterns 3 constituting the linear pattern pair is calculated as the average actual interval using only the normally printed image of the linear pattern 3. Since the ideal position 65 is calculated assuming that the interval between the two linear patterns 3 constituting each linear pattern pair is such an average actual interval, the ideal position 65 of each linear pattern 3 is accurately obtained.

### <1.8.2 Second Modification>

In the first embodiment, for each block 31, the actual position of the linear pattern 3 where the minimum average error 63 is obtained is set as the reference position 64. In this case, if the minimum average error 63 is a large value, an inappropriate position is set as the reference position 64. Therefore, in the present modified example, for the block 31 in which the minimum average error 63 is larger than a predetermined threshold, the reference position 64 is set on the basis of the positions of the linear patterns 3 in the two blocks 31 adjacent in the conveyance direction of the printing paper 5. Details will be described below.

It is assumed that the image as illustrated in FIG. 21 is extracted as the image of the inspection range 6 in step S30 in FIG. 12. In the example illustrated in FIG. 21, regarding the block 31(2), the average error 63 is a relatively large value for any of the three linear patterns 3 except for the linear patterns 3 at both ends. Here, focusing on the block 31(1), the interval between a linear pattern 791 and a linear pattern 792 is close to the theoretical value 61 of the interval between two linear patterns, and the interval between the linear pattern 792 and a linear pattern 793 is also close to the theoretical value 61 of the interval between two linear patterns. Furthermore, focusing on the block 31(3), the interval between a linear pattern 794 and a linear pattern 795 is close to the theoretical value 61 of the interval between two linear patterns, and the interval between the linear pattern 795 and a linear pattern 796 is also close to the theoretical value 61 of the interval between two linear patterns. In such a case, the gravity center position of the six linear patterns 791 to 796 (position indicated by a dotted line denoted by reference sign 79a in FIG. 21) is considered to be an ideal position of a linear pattern 79b. Furthermore, it is considered that the ideal position 65 of each linear pattern 3 in the block 31(2) is accurately obtained by setting the ideal position to the reference position 64 for the block 31(2). Therefore, in this example, the gravity center position of the six linear patterns 791 to 796 is set as the reference position 64 for the block 31(2).

More specifically, in the present modification, assuming that the number of blocks 31 is K, Q is an integer of 2 or more and (K−1) or less, and J is an integer of 2 or more and (N−1) or less (here, N is the number of linear patterns 3 included in each block 31), for a Qth block in which the minimum average error 63 obtained in step S60 in FIG. 12 is larger than a predetermined threshold, in step S70 in FIG. 12, when the average error 63 obtained in step S60 described above for a Jth linear pattern 3 included in a (Q−1)th block is less than or equal to the predetermined threshold and the average error 63 obtained in step S60 described above for a Jth linear pattern 3 included in a (Q+1)th block is less than or equal to the predetermined threshold, a gravity center position calculated from an actual position of a (J−1)th linear pattern 3 included in the (Q−1)th block, an actual position of the Jth linear pattern 3 included in the (Q−1)th block, an actual position of a (J+1)th linear pattern 3 included in the (Q−1)th block, an actual position of the (J−1)th linear pattern 3 included in the (Q+1)th block, an actual position of the Jth linear pattern 3 included in the (Q+1)th block, and an actual position of a (J+1)th linear pattern 3 included in the (Q+1)th block is set as the reference position 64. Note that, for the first block, the Kth block, and the block in which the minimum average error 63 obtained in step S60 is equal to or less than the predetermined threshold, the actual position of the linear pattern 3 in which the minimum average error 63 is obtained in step S60 among the (N−2) linear patterns 3 is set as the reference position 64 in step S70.

According to the present modification, it is possible to correctly obtain the ideal position 65 of each linear pattern 3 even for the block 31 in which there is no linear pattern pair where the interval between two linear patterns is close to the theoretical value 61.

### 2. Second Embodiment

### <2.1 Outline>

In the first embodiment, it is assumed that a nozzle causing a landing position shift in the paper width direction is detected. However, for example, as illustrated in a dotted line portion denoted by reference sign 80 in FIG. 22, a landing position shift in the conveyance direction of the printing paper 5 may occur. Therefore, an embodiment in which a defective nozzle is detected on the basis of the position (Y-coordinate value), in the conveyance direction of the printing paper 5, of the linear pattern 3 in the captured image 60 will be described as a second embodiment of the present invention.

The overall configuration of the inkjet printing apparatus 10 (see FIG. 1), the configuration of the recording section 205 (see FIG. 2), the arrangement of the nozzles 252 in the ink ejection head 251 (see FIG. 3), the hardware configuration of the print control device 100 (see FIG. 4), the schematic functional configuration of the control section 130 (see FIG. 5), and the configuration of the defective nozzle detection section 136 (see FIG. 11) are similar to those of the first embodiment. However, the detailed operation of each component in the defective nozzle detection section 136 is different from that of the first embodiment.

As the test chart 30, the same one as that of the first embodiment is used. However, in the present embodiment, the test chart 30 is divided into a plurality of blocks such that the plurality of linear patterns 3 to be formed at positions having same Y coordinate value are included in different blocks and the plurality of linear patterns 3 to be formed at positions having close X coordinate values are included in the same block. More specifically, as illustrated in FIG. 23, one block is formed for each of the five linear patterns 3 forming one collective stepwise pattern. In the example illustrated in FIG. 23, since the test chart 30 includes 25 linear patterns 3, the test chart 30 is divided into five blocks 33(1) to 33(5).

The test chart 30 in a portion corresponding to the inspection range 6 in the present embodiment will be generalized. Assuming that K is an integer of 3 or more, the test chart 30 includes a plurality of linear patterns 3 to be formed by ejecting ink from the plurality of nozzles 252, and is divided into K blocks in the paper width direction. Assuming that N is an integer of 4 or more, each of the K blocks includes N linear patterns 3 to be formed such that an interval (interval between gravity center positions) between two linear patterns 3 whose positions in the conveyance direction of the printing paper 5 are adjacent is constant. The test chart 30 is configured such that the N linear patterns 3 included in the Pth block are each formed at a position shifted by a certain distance in the paper width direction from the N linear patterns 3 included in the (P−1)th block, where P is an integer of 2 to K.

### <2.2 Defective Nozzle Detection Method>

A detailed procedure of the processing of detecting a defective nozzle will be described with reference to the flowchart illustrated in FIG. 12. Processing in steps S10 to S30 is similar to that of the first embodiment.

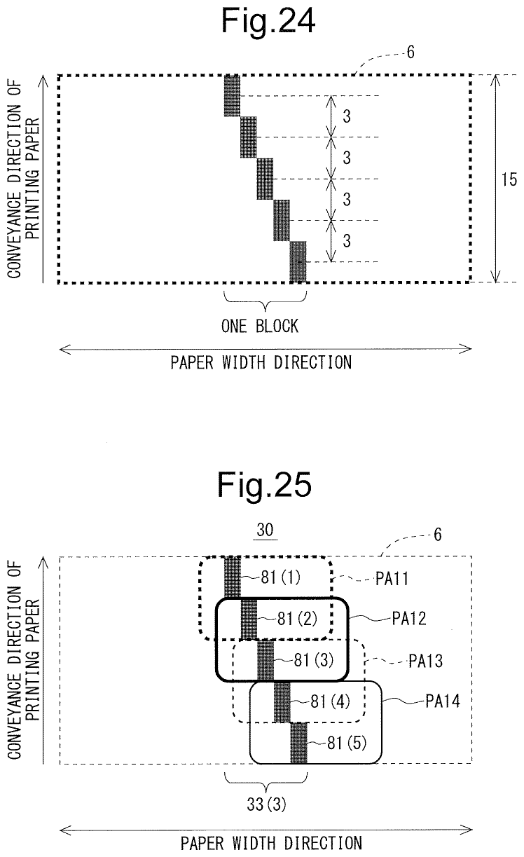

After the image in the inspection range 6 is extracted in step S30, the theoretical value calculation section 361 calculates the theoretical value 61 of the interval between the two linear patterns 3 adjacent in position in the conveyance direction of the printing paper 5 (step S40). In step S40, specifically, the theoretical value 61 is calculated based on the distance from the upper end to the lower end of the inspection range 6, the number of linear patterns 3 to be included in the image (captured image 60) extracted in step S30, and the number of blocks 33. In the present embodiment, the Y coordinate values of the upper end and the lower end of the inspection range 6 are fixed values. Here, it is assumed that the distance from the upper end to the lower end of the inspection range 6 is 15 (see FIG. 24). Furthermore, the number of linear patterns 3 to be included in each block 33 is 5 (see FIG. 23). Therefore, the theoretical value 61 is calculated as 3 by dividing 15 by 5. Note that, as illustrated in FIG. 24, the interval between the two linear patterns 3 is a distance from the Y-coordinate value of the gravity center position of one of the two linear patterns 3 to the Y-coordinate value of the gravity center position of the other of the two linear patterns 3.

Next, on the basis of the captured image 60, the actual value calculation section 362 calculates the actual value (value in the captured image 60) 62 of the interval between the two linear patterns 3 for all combinations of the two linear patterns 3 adjacent in position in the conveyance direction of the printing paper 5 (step S50). In this regard, when two linear patterns 3 adjacent in position in the conveyance direction of the printing paper 5 are defined as a “linear pattern pair”, each block 33 includes four linear pattern pairs. For example, when reference signs 81(1) to 81(5) are assigned to the five linear patterns 3 included in the block 33(3) as illustrated in FIG. 25, the block 33(3) includes a linear pattern pair PA11 configured by a linear pattern 81(1) and a linear pattern 81(2), a linear pattern pair PA12 configured by the linear pattern 81(2) and a linear pattern 81(3), a linear pattern pair PA13 configured by the linear pattern 81(3) and a linear pattern 81(4), and a linear pattern pair PA14 configured by the linear pattern 81(4) and a linear pattern 81(5). In this way, four linear pattern pairs are configured by the five linear patterns 3. In step S50, the actual value 62 of the interval between the two linear patterns 3 constituting such a linear pattern pair is obtained. From the above, in step S50, with the combination of the two linear patterns 3 adjacent in the position in the conveyance direction of the printing paper 5 regarded as the linear pattern pair, for each of the (N−1) linear pattern pairs (in the example illustrated in FIG. 23, four linear pattern pairs) configured by the N linear patterns (in the example illustrated in FIG. 23, five linear patterns) 3 included in each of the plurality of blocks 33, the actual value 62 of the interval between the two linear patterns 3 constituting the linear pattern pair is calculated on the basis of the captured image 60.

Next, the error calculation section 363 calculates the average error 63 for each linear pattern 3 except for the linear patterns 3 located at both ends (upper end and lower end) of each block 33 (step S60). In this regard, the linear patterns 3 other than the linear patterns 3 located at both ends of each block 33 form a linear pattern pair with the linear pattern 3 adjacent to the downstream side in the conveyance direction of the printing paper 5, and also form a linear pattern pair with the linear pattern 3 adjacent to the upstream side in the conveyance direction of the printing paper 5. Here, one of the two linear pattern pairs configured as described above is defined as a “first linear pattern pair”, and the other is defined as a “second linear pattern pair”. In step S60, for each linear pattern 3 excluding the linear patterns 3 located at both ends of each block 33, a difference between the theoretical value 61 calculated in step S40 and the actual value 62 calculated in step S50 for the first linear pattern pair is calculated as a first error, and a difference between the theoretical value 61 calculated in step S40 and the actual value 62 calculated in step S50 for the second linear pattern pair is calculated as a second error. Then, the average of the first error and the second error is calculated as the average error 63. From the above, in step S60, for each of the (N−2) linear patterns (in the example illustrated in FIG. 23, three linear patterns) 3 excluding the linear patterns 3 at both ends among the N linear patterns (in the example illustrated in FIG. 23, five linear patterns) 3 included in each of the plurality of blocks 33, the first error that is the difference between the theoretical value 61 and the actual value 62 for the first linear pattern pair, the second error that is the difference between the theoretical value 61 and the actual value 62 for the second linear pattern pair, and the average error 63 that is the average of the first error and the second error are calculated.

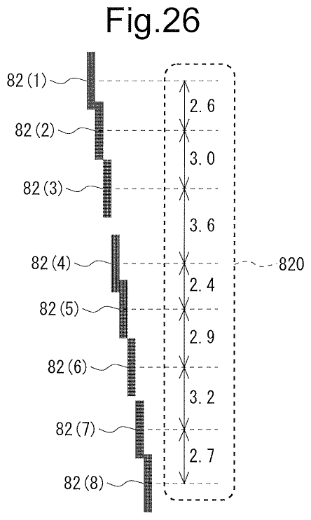

After the average error 63 is calculated, the reference position setting section 364 sets the actual position of the linear pattern 3 where the minimum average error 63 is obtained as the reference position 64 for each block 33 (step S70). Specifically, in step S70, for each of the plurality of blocks 33, the actual position (position in the captured image 60) of the linear pattern 3 for which the minimum average error 63 has been obtained in step S60 described above among the (N−2) linear patterns (in the example illustrated in FIG. 23, three linear patterns) 3 is set as the reference position 64. For example, it is assumed that a certain block 33 includes eight linear patterns 82(1) to 82(8) as illustrated in FIG. 26. An actual value 62 of the interval between the two linear patterns 3 adjacent in the conveyance direction of the printing paper 5 is written in a dotted line portion denoted by reference sign 820. In this example, in step S60, the average error 63 is calculated for each of the six linear patterns 82(2) to 82(7). When the theoretical value 61 calculated in step S40 is 3, the linear pattern 82(6) obtains the minimum average error 63 among the linear patterns 82(2) to 82(7). Therefore, the actual position of the linear pattern 82(6) is set to the reference position 64.

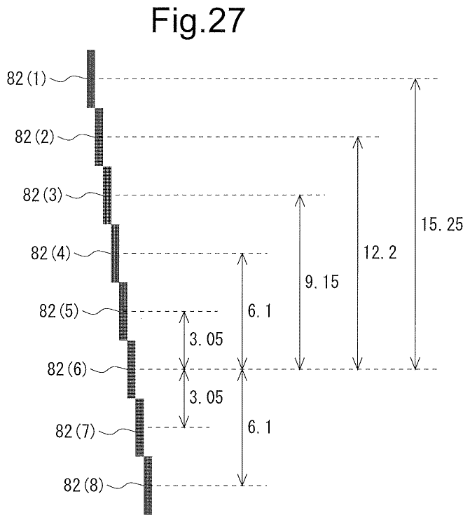

After setting the reference position 64, the ideal position calculation section 365 calculates the ideal position 65, which is the position where each linear pattern 3 is to be formed, on the basis of the reference position 64 (step S80). Specifically, when two linear patterns adjacent in the conveyance direction of the printing paper 5 to the linear pattern 3 corresponding to the reference position 64 are defined as a first adjacent linear pattern and a second adjacent linear pattern, in step S80, the average of the actual value 62 of the interval between the linear pattern 3 corresponding to the reference position 64 and the first adjacent linear pattern and the actual value 62 of the interval between the linear pattern 3 corresponding to the reference position 64 and the second adjacent linear pattern is calculated as the average actual interval, and the ideal position 65 is calculated assuming that the interval between the two linear patterns 3 constituting each linear pattern pair is the average actual interval. In this regard, in the example illustrated in FIG. 26, the linear pattern 82(6) is a linear pattern corresponding to the reference position 64, the linear pattern 82(5) is a first adjacent linear pattern, and the linear pattern 82(7) is a second adjacent linear pattern. The actual value 62 of the interval between the linear pattern 82(6) corresponding to the reference position 64 and the first adjacent linear pattern 82(5) is 2.9, and the actual value 62 of the interval between the linear pattern 82(6) corresponding to the reference position 64 and the second adjacent linear pattern 82(7) is 3.2. Therefore, the average actual interval is 3.05. In this case, as illustrated in FIG. 27, by adding or subtracting an integral multiple of 3.05, which is the average actual interval, to or from the Y coordinate value of the reference position 64 (actual position of the linear pattern 82(6)), the ideal position 65 of each of the linear patterns 82(1) to 82(5) and 82(7) to 82(8) other than the linear pattern 82(6) corresponding to the reference position 64 is calculated.

Next, for each linear pattern 3, the difference calculation section 366 calculates a difference 66 in the conveyance direction of the printing paper 5 between the ideal position 65 calculated in step S80 and the actual position based on the captured image 60 (step S90). Finally, the defect determination section 367 determines whether or not the nozzle corresponding to each linear pattern 3 is a defective nozzle on the basis of the difference 66 calculated in step S90 (step S100). Thus, the processing of detecting a defective nozzle ends.

### <2.3 Effects>

According to the present embodiment, on the basis of the captured image 60 of the print image of the test chart 30 divided into the five blocks 33(1) to 33(5) in the paper width direction (direction in which the plurality of nozzles 252 is arranged), for each linear pattern 3 (excluding the linear patterns 3 at both ends) included in each of the five blocks 33(1) to 33(5), the average error 63 representing how close the interval with two linear patterns 3 each adjacent in position in the conveyance direction of the printing paper 5 is to the theoretical value 61 is calculated. Then, the actual position of the linear pattern 3 where the minimum average error 63 is obtained is set as the reference position 64, and the ideal position 65 of each linear pattern 3 is calculated on the basis of the reference position 64. Therefore, unlike the conventional method, even if the nozzle 252 corresponding to the linear pattern 3 at the end portion of each block 33 is a defective nozzle, the reference position 64 in each block 33 can be correctly obtained, so that the ideal position 65 of each linear pattern 3 can be correctly obtained. As a result, the difference (difference in the conveyance direction of the printing paper 5) 66 between the actual position of each linear pattern 3 and the ideal position 65 is accurately calculated, so that it is possible to accurately determine whether or not the nozzle corresponding to each linear pattern 3 is a defective nozzle. As above, according to the present embodiment, as in the first embodiment, regarding the inkjet printing apparatus 10, a defective nozzle can be detected with higher accuracy than before. Therefore, since wasteful consumption of the printing paper 5 and ink caused by reprinting is suppressed, it is possible to contribute to the achievement of sustainable development targets (SDGs).

### <2.4 Modifications>

Also in the present embodiment, modifications (a first modification and a second modification) similar to those of the first embodiment can be adopted. Specific examples thereof will be described below.

### <2.4.1 First Modification>

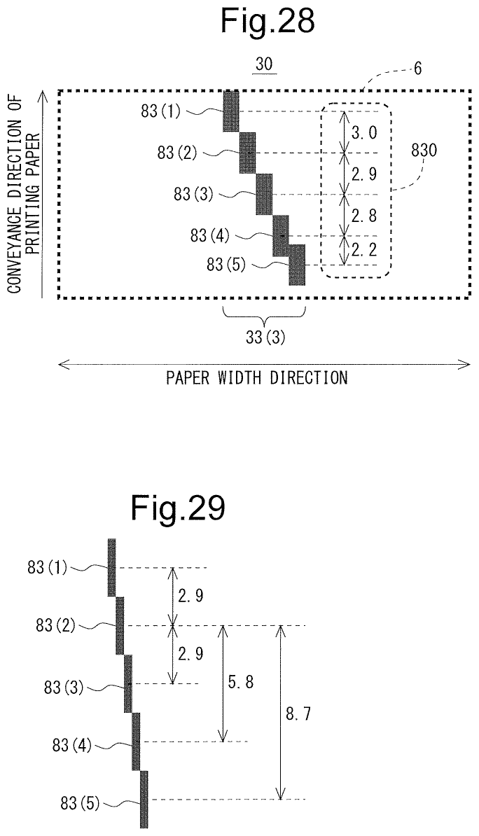

Here, a case where the block 33(3) includes five linear patterns 83(1) to 83(5) as illustrated in FIG. 28 is assumed. An actual value 62 of the interval between two linear patterns adjacent in the conveyance direction of the printing paper 5 is written in a dotted line portion denoted by reference sign 830. Note that the position of the linear pattern 83(2) is the reference position 64. Here, it is assumed that a threshold for comparing with the difference between the actual value 62 and the theoretical value 61 is set to 0.5. In this case, the difference is larger than the threshold for the linear pattern pair configured by the linear pattern 83(4) and the linear pattern 83(5), and the difference is less than or equal to the threshold for other linear pattern pairs. Therefore, the average actual interval in this example is 2.9 which is an average of 3.0 which is the actual value 62 for the linear pattern pair configured by the linear pattern 83(1) and the linear pattern 83(2), 2.9 which is the actual value 62 for the linear pattern pair configured by the linear pattern 83(2) and the linear pattern 83(3), and 2.8 which is the actual value 62 for the linear pattern pair configured by the linear pattern 83(3) and the linear pattern 83(4). Then, as illustrated in FIG. 29, by adding or subtracting an integral multiple of 2.9, which is the average actual interval, to or from the Y coordinate value of the reference position 64 (actual position of the linear pattern 83(2)), the ideal position 65 of each of the linear patterns 83(1) and 83(3) to 83(5) other than the linear pattern 83(2) corresponding to the reference position 64 is calculated.

### <2.4.2 Second Modification>

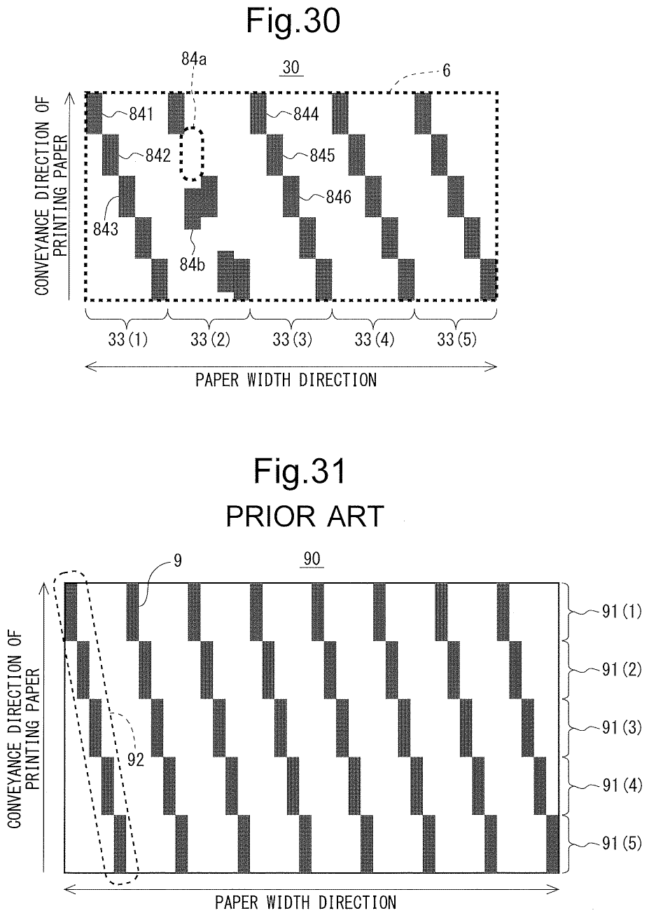

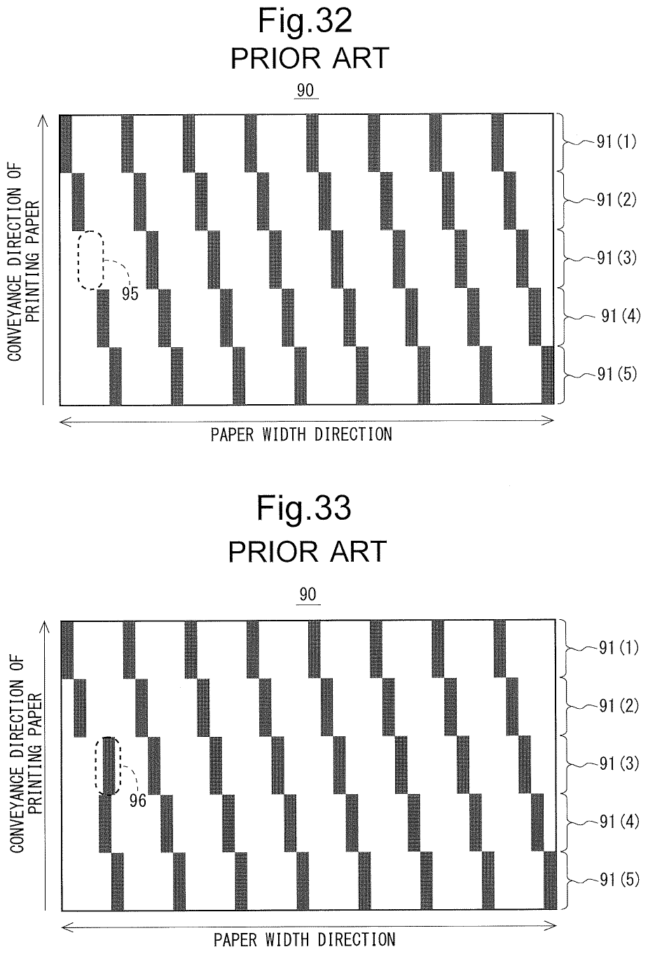

It is assumed that the image as illustrated in FIG. 30 is extracted as the image of the inspection range 6 in step S30 in FIG. 12. In the example illustrated in FIG. 30, regarding the block 33(2), the average error 63 is a relatively large value for any of the three linear patterns 3 except for the linear patterns 3 at both ends (upper end and lower end). Here, focusing on the block 33(1), the interval between the linear pattern 841 and the linear pattern 842 is close to the theoretical value 61 of the interval between two linear patterns, and the interval between the linear pattern 842 and the linear pattern 843 is also close to the theoretical value 61 of the interval between two linear patterns. Furthermore, focusing on the block 33(3), the interval between the linear pattern 844 and the linear pattern 845 is close to the theoretical value 61 of the interval between two linear patterns, and the interval between the linear pattern 845 and the linear pattern 846 is also close to the theoretical value 61 of the interval between two linear patterns. In the present modification, in such an example, the gravity center position of the six linear patterns 841 to 846 is set as the reference positions 64 for the block 33(2), similarly to the second modification of the first embodiment.

### 3. Supplementary Note

The configurations described below are conceivable from the above disclosure.

### <Supplementary Note 1>

A defective nozzle detection method of detecting a defective nozzle in a printing apparatus including a print head including a plurality of nozzles arranged in a first direction and configured to perform printing on a print medium by ejecting ink from the plurality of nozzles, the defective nozzle detection method including:
a test chart printing step of printing a test chart including a plurality of linear patterns to be formed by ejecting ink from the plurality of nozzles and configured to be divided into a plurality of blocks in a second direction orthogonal to the first direction while relatively moving a positional relationship between the print head and the print medium in the second direction, each of the plurality of blocks including N linear patterns (N is an integer of 4 or more) to be formed so that an interval between two linear patterns adjacent in the first direction is constant;
an imaging step of acquiring a captured image by capturing a print image obtained in the test chart printing step;
a theoretical value calculation step of calculating a theoretical value of the interval between the two linear patterns adjacent in the first direction;
an actual value calculation step of calculating an actual value of an interval between the two linear patterns constituting a linear pattern pair on a basis of the captured image for each of (N−1) linear pattern pairs constituted by the N linear patterns included in each of the plurality of blocks, the linear pattern pair being a combination of the two linear patterns adjacent in the first direction;
an error calculation step of calculating a first error, a second error, and an average error for each of (N−2) linear patterns excluding linear patterns at both ends among the N linear patterns included in each of the plurality of blocks, the first error being a difference between the theoretical value and an actual value for a first linear pattern pair, the second error being a difference between the theoretical value and an actual value for a second linear pattern pair, the average error being an average of the first error and the second error, the first linear pattern pair being one of two linear pattern pairs including each linear pattern excluding the linear patterns at both ends among the N linear patterns, and the second linear pattern pair being another of the two linear pattern pairs;
a reference position setting step of setting, for each of the plurality of blocks, an actual position of a linear pattern in which a minimum average error is obtained in the error calculating step among the (N−2) linear patterns as a reference position;
an ideal position calculation step of calculating an ideal position at which each linear pattern is to be formed, on a basis of the reference position;
a difference calculation step of calculating a difference in the first direction between the ideal position and the actual position based on the captured image for each linear pattern; and
a defect determination step of determining whether or not a nozzle corresponding to each linear pattern is a defective nozzle on a basis of the difference.

### <Supplementary Note 2>

The defective nozzle detection method according to Supplementary note 1, wherein in the ideal position calculation step, the ideal position is calculated on a basis of an actual value of an interval between a linear pattern corresponding to the reference position and a first adjacent linear pattern and an actual value of an interval between the linear pattern corresponding to the reference position and a second adjacent linear pattern, the first adjacent linear pattern and the second adjacent linear pattern being two linear patterns adjacent to the linear pattern corresponding to the reference position in the first direction.

### <Supplementary Note 3>

The defective nozzle detection method according to Supplementary note 2, wherein in the ideal position calculation step, an average of the actual value of the interval between the linear pattern corresponding to the reference position and the first adjacent linear pattern and the actual value of the interval between the linear pattern corresponding to the reference position and the second adjacent linear pattern is calculated as an average actual interval, and the ideal position is calculated assuming that an interval between two linear patterns constituting each linear pattern pair is the average actual interval.

### <Supplementary Note 4>

The defective nozzle detection method according to Supplementary note 1, wherein in the ideal position calculation step, an average of actual values for linear pattern pairs for which a difference between an actual value calculated in the actual value calculation step and a theoretical value calculated in the theoretical value calculation step is less than or equal to a predetermined threshold among the (N−1) linear pattern pairs is calculated as an average actual interval for each of the plurality of blocks, and the ideal position is calculated assuming that an interval between two linear patterns constituting each linear pattern pair is the average actual interval.

### <Supplementary Note 5>

The defective nozzle detection method according to Supplementary note 1, wherein the test chart includes a first mark representing a first predetermined position in the first direction and a second mark representing a second predetermined position in the first direction,
the defective nozzle detection method includes an image extraction step of extracting an image in a range between the first mark and the second mark in the first direction from the captured image, and
in the theoretical value calculation step, the theoretical value is calculated on a basis of a distance between the first mark and the second mark, a number of linear patterns to be included in an image extracted in the image extraction step, and a number of blocks.

### <Supplementary Note 6>

The defective nozzle detection method according to Supplementary note 1, wherein
the plurality of blocks is K blocks (K is an integer of 3 or more), and
the test chart is configured such that N linear patterns included in a Pth block are formed at positions shifted by a certain distance in the first direction from N linear patterns included in a (P−1)th block, the P being an integer of 2 or more and K or less.

### <Supplementary Note 7>

A defective nozzle detection method of detecting a defective nozzle in a printing apparatus including a print head including a plurality of nozzles arranged in a first direction and configured to perform printing on a print medium by ejecting ink from the plurality of nozzles, the defective nozzle detection method including:
a test chart printing step of printing a test chart including a plurality of linear patterns to be formed by ejecting ink from the plurality of nozzles and configured to be divided into a plurality of blocks in a second direction orthogonal to the first direction while relatively moving a positional relationship between the print head and the print medium in the second direction, each of the plurality of blocks including N linear patterns (N is an integer of 4 or more) to be formed so that an interval between two linear patterns adjacent in the first direction is constant;
an imaging step of acquiring a captured image by capturing a print image obtained in the test chart printing step;
a theoretical value calculation step of calculating a theoretical value of the interval between the two linear patterns adjacent in the first direction;
an actual value calculation step of calculating an actual value of an interval between the two linear patterns constituting a linear pattern pair on a basis of the captured image for each of (N−1) linear pattern pairs constituted by the N linear patterns included in each of the plurality of blocks, the linear pattern pair being a combination of the two linear patterns adjacent in the first direction;
an error calculation step of calculating a first error, a second error, and an average error for each of (N−2) linear patterns excluding linear patterns at both ends among the N linear patterns included in each of the plurality of blocks, the first error being a difference between the theoretical value and an actual value for a first linear pattern pair, the second error being a difference between the theoretical value and an actual value for a second linear pattern pair, the average error being an average of the first error and the second error, the first linear pattern pair being one of two linear pattern pairs including each linear pattern excluding the linear patterns at both ends among the N linear patterns, and the second linear pattern pair being another of the two linear pattern pairs;
a reference position setting step of setting a reference position for each of the plurality of blocks;
an ideal position calculation step of calculating an ideal position at which each linear pattern is to be formed, on a basis of the reference position;
a difference calculation step of calculating a difference in the first direction between the ideal position and the actual position based on the captured image for each linear pattern; and
a defect determination step of determining whether or not a nozzle corresponding to each linear pattern is a defective nozzle on a basis of the difference,
wherein the plurality of blocks is K blocks (K is an integer of 3 or more),
the test chart is configured such that N linear patterns included in a Pth block are formed at positions shifted by a certain distance in the first direction from N linear patterns included in a (P−1)th block, the P being an integer of 2 or more and K or less,
for a first block, a Kth block, and a block in which a minimum average error obtained in the error calculation step is less than or equal to a predetermined threshold, in the reference position setting step, an actual position of a linear pattern in which a minimum average error is obtained in the error calculation step among the (N−2) linear patterns is set as the reference position, and
for a Qth block in which a minimum average error obtained in the error calculation step is larger than the predetermined threshold, in the reference position setting step, when an average error obtained in the error calculation step for a Jth linear pattern included in a (Q−1)th block is less than or equal to the predetermined threshold, and an average error obtained in the error calculation step for a Jth linear pattern included in a (Q+1)th block is less than or equal to the predetermined threshold, the reference position is set on a basis of an actual position of a linear pattern included in the (Q−1)th block and an actual position of a linear pattern included in the (Q+1)th block, the Q being an integer of 2 or more and (K−1) or less, and the J being an integer of 2 or more and (N−1) or less.

### <Supplementary Note 8>

The defective nozzle detection method according to Supplementary note 7, wherein for the Qth block in which the minimum average error obtained in the error calculation step is larger than the predetermined threshold, in the reference position setting step, a gravity center position calculated from an actual position of a (J−1)th linear pattern included in the (Q−1)th block, an actual position of a Jth linear pattern included in the (Q−1)th block, an actual position of a (J+1)th linear pattern included in the (Q−1)th block, an actual position of a (J−1)th linear pattern included in the (Q+1)th block, an actual position of a Jth linear pattern included in the (Q+1)th block, and an actual position of a (J+1)th linear pattern included in the (Q+1)th block is set as the reference position.

### <Supplementary Note 9>

A defective nozzle detection method of detecting a defective nozzle in a printing apparatus including a print head including a plurality of nozzles arranged in a first direction and configured to perform printing on a print medium by ejecting ink from the plurality of nozzles, the defective nozzle detection method including:
a test chart printing step of printing a test chart including a plurality of linear patterns to be formed by ejecting ink from the plurality of nozzles and configured to be divided into a plurality of blocks in a first direction while relatively moving a positional relationship between the print head and the print medium in a second direction orthogonal to the first direction, each of the plurality of blocks including N linear patterns (N is an integer of 4 or more) to be formed so that an interval between two linear patterns whose positions in the second direction are adjacent is constant;
imaging step of acquiring a captured image by capturing a print image obtained in the test chart printing step;
a theoretical value calculation step of calculating a theoretical value of the interval between two linear patterns whose positions in the second direction are adjacent;
an actual value calculation step of calculating an actual value of an interval between the two linear patterns constituting a linear pattern pair on a basis of the captured image for each of (N−1) linear pattern pairs constituted by the N linear patterns included in each of the plurality of blocks, the linear pattern pair being a combination of the two linear patterns whose positions in the second direction are adjacent;
an error calculation step of calculating a first error, a second error, and an average error for each of (N−2) linear patterns excluding linear patterns at both ends among the N linear patterns included in each of the plurality of blocks, the first error being a difference between the theoretical value and an actual value for a first linear pattern pair, the second error being a difference between the theoretical value and an actual value for a second linear pattern pair, the average error being an average of the first error and the second error, the first linear pattern pair being one of two linear pattern pairs including each linear pattern excluding the linear patterns at both ends among the N linear patterns, and the second linear pattern pair being another of the two linear pattern pairs;
a reference position setting of setting, for each of the plurality of blocks, an actual position of a linear pattern in which a minimum average error is obtained in the error calculation step among the (N−2) linear patterns as a reference position;
an ideal position calculation step of calculating an ideal position at which each linear pattern is to be formed, on a basis of the reference position;
a difference calculation step of calculating a difference in the second direction between the ideal position and the actual position based on the captured image for each linear pattern; and
a defect determination step of determining whether or not a nozzle corresponding to each linear pattern is a defective nozzle on a basis of the difference.

### <Supplementary Note 10>

The defective nozzle detection method according to Supplementary note 9, wherein in the ideal position calculation step, the ideal position is calculated on a basis of an actual value of an interval between a linear pattern corresponding to the reference position and a first adjacent linear pattern and an actual value of an interval between the linear pattern corresponding to the reference position and a second adjacent linear pattern, the first adjacent linear pattern and the second adjacent linear pattern being two linear patterns adjacent to the linear pattern corresponding to the reference position in the second direction.

### <Supplementary Note 11>

The defective nozzle detection method according to Supplementary note 10, wherein in the ideal position calculation step, an average of the actual value of the interval between the linear pattern corresponding to the reference position and the first adjacent linear pattern and the actual value of the interval between the linear pattern corresponding to the reference position and the second adjacent linear pattern is calculated as an average actual interval, and the ideal position is calculated assuming that an interval between two linear patterns constituting each linear pattern pair is the average actual interval.

### <Supplementary Note 12>

The defective nozzle detection method according to Supplementary note 9, wherein in the ideal position calculation step, an average of actual values for linear pattern pairs for which a difference between an actual value calculated in the actual value calculation step and a theoretical value calculated in the theoretical value calculation step is less than or equal to a predetermined threshold among the (N−1) linear pattern pairs is calculated as an average actual interval for each of the plurality of blocks, and the ideal position is calculated assuming that an interval between two linear patterns constituting each linear pattern pair is the average actual interval.

### <Supplementary Note 13>

A defective nozzle detection method of detecting a defective nozzle in a printing apparatus including a print head including a plurality of nozzles arranged in a first direction and configured to perform printing on a print medium by ejecting ink from the plurality of nozzles, the defective nozzle detection method including:
a test chart printing step of printing a test chart including a plurality of linear patterns to be formed by ejecting ink from the plurality of nozzles and configured to be divided into a plurality of blocks in a first direction while relatively moving a positional relationship between the print head and the print medium in a second direction orthogonal to the first direction, each of the plurality of blocks including N linear patterns (N is an integer of 4 or more) to be formed so that an interval between two linear patterns whose positions in the second direction are adjacent is constant;
an imaging step of acquiring a captured image by capturing a print image obtained in the test chart printing step;
a theoretical value calculation step of calculating a theoretical value of the interval between two linear patterns whose positions in the second direction are adjacent;
an actual value calculation step of calculating an actual value of an interval between the two linear patterns constituting a linear pattern pair on a basis of the captured image for each of (N−1) linear pattern pairs constituted by the N linear patterns included in each of the plurality of blocks, the linear pattern pair being a combination of the two linear patterns whose positions in the second direction are adjacent;
an error calculation step of calculating a first error, a second error, and an average error for each of (N−2) linear patterns excluding linear patterns at both ends among the N linear patterns included in each of the plurality of blocks, the first error being a difference between the theoretical value and an actual value for a first linear pattern pair, the second error being a difference between the theoretical value and an actual value for a second linear pattern pair, the average error being an average of the first error and the second error, the first linear pattern pair being one of two linear pattern pairs including each linear pattern excluding the linear patterns at both ends among the N linear patterns, and the second linear pattern pair being another of the two linear pattern pairs;
a reference position setting step of setting a reference position for each of the plurality of blocks;
an ideal position calculation step of calculating an ideal position at which each linear pattern is to be formed, on a basis of the reference position;
a difference calculation step of calculating a difference in the second direction between the ideal position and the actual position based on the captured image for each linear pattern; and
a defect determination step of determining whether or not a nozzle corresponding to each linear pattern is a defective nozzle on a basis of the difference,
wherein the plurality of blocks is K blocks (K is an integer of 3 or more),
the test chart is configured such that N linear patterns included in a Pth block are formed at positions shifted by a certain distance in the first direction from N linear patterns included in a (P−1)th block, the P being an integer of 2 or more and K or less,
for a first block, a Kth block, and a block in which a minimum average error obtained in the error calculation step is less than or equal to a predetermined threshold, in the reference position setting step, an actual position of a linear pattern in which a minimum average error is obtained in the error calculation step among the (N−2) linear patterns is set as the reference position, and
for a Qth block in which a minimum average error obtained in the error calculation step is larger than the predetermined threshold, in the reference position setting step, when an average error obtained in the error calculation step for a Jth linear pattern included in a (Q−1)th block is less than or equal to the predetermined threshold, and an average error obtained in the error calculation step for a Jth linear pattern included in a (Q+1)th block is less than or equal to the predetermined threshold, the reference position is set on a basis of an actual position of a linear pattern included in the (Q−1)th block and an actual position of a linear pattern included in the (Q+1)th block, the Q being an integer of 2 or more and (K−1) or less, and the J being an integer of 2 or more and (N−1) or less.

### <Supplementary Note 14>

The defective nozzle detection method according to Supplementary note 13, wherein for the Qth block in which the minimum average error obtained in the error calculation step is larger than the predetermined threshold, in the reference position setting step, a gravity center position calculated from an actual position of a (J−1)th linear pattern included in the (Q−1)th block, an actual position of a Jth linear pattern included in the (Q−1)th block, an actual position of a (J+1)th linear pattern included in the (Q−1)th block, an actual position of a (J−1)th linear pattern included in the (Q+1)th block, an actual position of a Jth linear pattern included in the (Q+1)th block, and an actual position of a (J+1)th linear pattern included in the (Q+1)th block is set as the reference position.

### <Supplementary Note 15>

A printing apparatus including:
a print head including a plurality of nozzles arranged in a first direction, the plurality of nozzles being configured to eject ink onto a print medium to form a print image on the print medium;
an imaging device configured to capture the print image; and
a defective nozzle detection section configured to detect a defective nozzle from among the plurality of nozzles on a basis of a captured image obtained by the imaging device capturing a print image of a test chart including a plurality of linear patterns to be formed by ejecting ink from the plurality of nozzles and configured to be divided into a plurality of blocks in a second direction orthogonal to the first direction, each of the plurality of blocks including N linear patterns (N is an integer of 4 or more) to be formed so that an interval between two linear patterns adjacent in the first direction is constant,
wherein the defective nozzle detection section includes:
a theoretical value calculation section configured to calculate a theoretical value of the interval between the two linear patterns adjacent in the first direction;
an actual value calculation section configured to calculate an actual value of an interval between the two linear patterns constituting a linear pattern pair on a basis of the captured image for each of (N−1) linear pattern pairs constituted by the N linear patterns included in each of the plurality of blocks, the linear pattern pair being a combination of the two linear patterns adjacent in the first direction;
an error calculation section configured to calculate a first error, a second error, and an average error for each of (N−2) linear patterns excluding linear patterns at both ends among the N linear patterns included in each of the plurality of blocks, the first error being a difference between the theoretical value and an actual value for a first linear pattern pair, the second error being a difference between the theoretical value and an actual value for a second linear pattern pair, the average error being an average of the first error and the second error, the first linear pattern pair being one of two linear pattern pairs including each linear pattern excluding the linear patterns at both ends among the N linear patterns, and the second linear pattern pair being another of the two linear pattern pairs;
a reference position setting section configured to set, for each of the plurality of blocks, an actual position of a linear pattern in which a minimum average error is obtained by the error calculation section among the (N−2) linear patterns as a reference position;
an ideal position calculation section configured to calculate an ideal position at which each linear pattern is to be formed, on a basis of the reference position;
a difference calculation section configured to calculate a difference in the first direction between the ideal position and the actual position based on the captured image for each linear pattern; and
a defect determination section configured to determine whether or not a nozzle corresponding to each linear pattern is a defective nozzle on a basis of the difference.

### <Supplementary Note 16>

A printing apparatus including:
a print head including a plurality of nozzles arranged in a first direction, the plurality of nozzles being configured to eject ink onto a print medium to form a print image on the print medium;
an imaging device configured to capture the print image; and
a defective nozzle detection section configured to detect a defective nozzle from among the plurality of nozzles on a basis of a captured image obtained by the imaging device capturing a print image of a test chart including a plurality of linear patterns to be formed by ejecting ink from the plurality of nozzles and configured to be divided into a plurality of blocks in a second direction orthogonal to the first direction, each of the plurality of blocks including N linear patterns (N is an integer of 4 or more) to be formed so that an interval between two linear patterns adjacent in the first direction is constant,
wherein the defective nozzle detection section includes:
a theoretical value calculation section configured to calculate a theoretical value of the interval between the two linear patterns adjacent in the first direction;
an actual value calculation section configured to calculate an actual value of an interval between the two linear patterns constituting a linear pattern pair on a basis of the captured image for each of (N−1) linear pattern pairs constituted by the N linear patterns included in each of the plurality of blocks, the linear pattern pair being a combination of the two linear patterns adjacent in the first direction;
an error calculation section configured to calculate a first error, a second error, and an average error for each of (N−2) linear patterns excluding linear patterns at both ends among the N linear patterns included in each of the plurality of blocks, the first error being a difference between the theoretical value and an actual value for a first linear pattern pair, the second error being a difference between the theoretical value and an actual value for a second linear pattern pair, the average error being an average of the first error and the second error, the first linear pattern pair being one of two linear pattern pairs including each linear pattern excluding the linear patterns at both ends among the N linear patterns, and the second linear pattern pair being another of the two linear pattern pairs;
a reference position setting section configured to set a reference position for each of the plurality of blocks;
an ideal position calculation section configured to calculate an ideal position at which each linear pattern is to be formed, on a basis of the reference position;
a difference calculation section configured to calculate a difference in the first direction between the ideal position and the actual position based on the captured image for each linear pattern; and
a defect determination section configured to determine whether or not a nozzle corresponding to each linear pattern is a defective nozzle on a basis of the difference,
the plurality of blocks is K blocks (K is an integer of 3 or more),
the test chart is configured such that N linear patterns included in a Pth block are formed at positions shifted by a certain distance in the first direction from N linear patterns included in a (P−1)th block, the P being an integer of 2 or more and K or less,
for a first block, a Kth block, and a block in which a minimum average error obtained by the error calculation section is less than or equal to a predetermined threshold, the reference position setting section sets, as the reference position, an actual position of a linear pattern in which a minimum average error is obtained by the error calculation section among the (N−2) linear patterns, and
for a Qth block in which a minimum average error obtained by the error calculation section is larger than the predetermined threshold, when an average error obtained by the error calculation section for a Jth linear pattern included in a (Q−1)th block is less than or equal to the predetermined threshold, and an average error obtained by the error calculation section for a Jth linear pattern included in a (Q+1)th block is less than or equal to the predetermined threshold, the reference position setting section sets the reference position on a basis of an actual position of a linear pattern included in the (Q−1)th block and an actual position of a linear pattern included in the (Q+1)th block, the Q being an integer of 2 or more and (K−1) or less, and the J being an integer of 2 or more and (N−1) or less.

### <Supplementary Note 17>

The printing apparatus according to Supplementary note 16, wherein for the Qth block in which the minimum average error obtained by the error calculation section is larger than the predetermined threshold, the reference position setting section sets, as the reference position, a gravity center position calculated from an actual position of a (J−1)th linear pattern included in the (Q−1)th block, an actual position of a Jth linear pattern included in the (Q−1)th block, an actual position of a (J+1)th linear pattern included in the (Q−1)th block, an actual position of a (J−1)th linear pattern included in the (Q+1)th block, an actual position of a Jth linear pattern included in the (Q+1)th block, and an actual position of a (J+1)th linear pattern included in the (Q+1)th block.

### <Supplementary Note 18>

A printing apparatus including:
a print head including a plurality of nozzles arranged in a first direction, the plurality of nozzles being configured to eject ink onto a print medium to form a print image on the print medium;
an imaging device configured to capture the print image; and
a defective nozzle detection section configured to detect a defective nozzle from among the plurality of nozzles on a basis of a captured image obtained by the imaging device capturing a print image of a test chart including a plurality of linear patterns to be formed by ejecting ink from the plurality of nozzles and configured to be divided into a plurality of blocks in the first direction, each of the plurality of blocks including N linear patterns (N is an integer of 4 or more) to be formed so that an interval between two linear patterns whose positions in a second direction orthogonal to the first direction are adjacent is constant,
wherein the defective nozzle detection section includes:
a theoretical value calculation section configured to calculate a theoretical value of the interval between two linear patterns whose positions in the second direction are adjacent;
an actual value calculation section configured to calculate an actual value of an interval between the two linear patterns constituting a linear pattern pair on a basis of the captured image for each of (N−1) linear pattern pairs constituted by the N linear patterns included in each of the plurality of blocks, the linear pattern pair being a combination of the two linear patterns whose positions in the second direction are adjacent;
an error calculation section configured to calculate a first error, a second error, and an average error for each of (N−2) linear patterns excluding linear patterns at both ends among the N linear patterns included in each of the plurality of blocks, the first error being a difference between the theoretical value and an actual value for a first linear pattern pair, the second error being a difference between the theoretical value and an actual value for a second linear pattern pair, the average error being an average of the first error and the second error, the first linear pattern pair being one of two linear pattern pairs including each linear pattern excluding the linear patterns at both ends among the N linear patterns, and the second linear pattern pair being another of the two linear pattern pairs;
a reference position setting section configured to set, for each of the plurality of blocks, an actual position of a linear pattern in which a minimum average error is obtained by the error calculation section among the (N−2) linear patterns as a reference position;
an ideal position calculation section configured to calculate an ideal position at which each linear pattern is to be formed, on a basis of the reference position;
a difference calculation section configured to calculate a difference in the second direction between the ideal position and the actual position based on the captured image for each linear pattern; and
a defect determination section configured to determine whether or not a nozzle corresponding to each linear pattern is a defective nozzle on a basis of the difference.

### <Supplementary Note 19>

A printing apparatus including:
a print head including a plurality of nozzles arranged in a first direction, the plurality of nozzles being configured to eject ink onto a print medium to form a print image on the print medium;
an imaging device configured to capture the print image; and
a defective nozzle detection section configured to detect a defective nozzle from among the plurality of nozzles on a basis of a captured image obtained by the imaging device capturing a print image of a test chart including a plurality of linear patterns to be formed by ejecting ink from the plurality of nozzles and configured to be divided into a plurality of blocks in the first direction, each of the plurality of blocks including N linear patterns (N is an integer of 4 or more) to be formed so that an interval between two linear patterns whose positions in a second direction orthogonal to the first direction are adjacent is constant,
wherein the defective nozzle detection section includes:
a theoretical value calculation section configured to calculate a theoretical value of the interval between two linear patterns whose positions in the second direction are adjacent;
an actual value calculation section configured to calculate an actual value of an interval between the two linear patterns constituting a linear pattern pair on a basis of the captured image for each of (N−1) linear pattern pairs constituted by the N linear patterns included in each of the plurality of blocks, the linear pattern pair being a combination of the two linear patterns whose positions in the second direction are adjacent;
an error calculation section configured to calculate a first error, a second error, and an average error for each of (N−2) linear patterns excluding linear patterns at both ends among the N linear patterns included in each of the plurality of blocks, the first error being a difference between the theoretical value and an actual value for a first linear pattern pair, the second error being a difference between the theoretical value and an actual value for a second linear pattern pair, the average error being an average of the first error and the second error, the first linear pattern pair being one of two linear pattern pairs including each linear pattern excluding the linear patterns at both ends among the N linear patterns, and the second linear pattern pair being another of the two linear pattern pairs;
a reference position setting section configured to set a reference position for each of the plurality of blocks;
an ideal position calculation section configured to calculate an ideal position at which each linear pattern is to be formed, on a basis of the reference position;
a difference calculation section configured to calculate a difference in the second direction between the ideal position and the actual position based on the captured image for each linear pattern; and
a defect determination section configured to determine whether or not a nozzle corresponding to each linear pattern is a defective nozzle on a basis of the difference,
the plurality of blocks is K blocks (K is an integer of 3 or more),
the test chart is configured such that N linear patterns included in a Pth block are formed at positions shifted by a certain distance in the first direction from N linear patterns included in a (P−1)th block, the P being an integer of 2 or more and K or less,
for a first block, a Kth block, and a block in which a minimum average error obtained by the error calculation section is less than or equal to a predetermined threshold, the reference position setting section sets, as the reference position, an actual position of a linear pattern in which a minimum average error is obtained by the error calculation section among the (N−2) linear patterns, and
when Q is and J is, for a Qth block in which a minimum average error obtained by the error calculation section is larger than the predetermined threshold, when an average error obtained by the error calculation section for a Jth linear pattern included in a (Q−1)th block is less than or equal to the predetermined threshold, and an average error obtained by the error calculation section for a Jth linear pattern included in a (Q+1)th block is less than or equal to the predetermined threshold, the reference position setting section sets the reference position on a basis of an actual position of a linear pattern included in the (Q−1)th block and an actual position of a linear pattern included in the (Q+1)th block, the Q being an integer of 2 or more and (K−1) or less, and the J being an integer of 2 or more and (N−1) or less.

### <Supplementary Note 20>

The printing apparatus according to Supplementary note 19, wherein for the Qth block in which the minimum average error obtained by the error calculation section is larger than the predetermined threshold, the reference position setting section sets, as the reference position, a gravity center position calculated from an actual position of a (J−1)th linear pattern included in the (Q−1)th block, an actual position of a Jth linear pattern included in the (Q−1)th block, an actual position of a (J+1)th linear pattern included in the (Q−1)th block, an actual position of a (J−1)th linear pattern included in the (Q+1)th block, an actual position of a Jth linear pattern included in the (Q+1)th block, and an actual position of a (J+1)th linear pattern included in the (Q+1)th block.

### 4. Others

Although the present invention has been described in detail above, the above description is illustrative in all aspects and is not restrictive. It is understood that numerous other changes and variations can be devised without departing from the scope of the invention. For example, in the above-described embodiments (including modifications), the inkjet printing apparatus 10 that performs color printing has been adopted. However, the present invention is not limited thereto, and an inkjet printing apparatus that performs monochrome printing may be adopted. Furthermore, in the above-described embodiments (including the modifications), the inkjet printing apparatus 10 using an aqueous ink is adopted. However, the present invention is not limited thereto, and for example, an inkjet printing apparatus using UV ink (ultraviolet curing ink) such as an inkjet printing apparatus for label printing may be adopted. In this case, an ultraviolet irradiation mechanism for curing the UV ink on the printing paper 5 by ultraviolet irradiation is provided inside the printing mechanism 201 (see FIG. 1) instead of the drying mechanism 206.

What is claimed is:

1. A defective nozzle detection method of detecting a defective nozzle in a printing apparatus including a print head including a plurality of nozzles arranged in a first direction and configured to perform printing on a print medium by ejecting ink from the plurality of nozzles, the defective nozzle detection method comprising:
printing a test chart including a plurality of linear patterns to be formed by ejecting ink from the plurality of nozzles and configured to be divided into a plurality of blocks in a second direction orthogonal to the first direction while relatively moving a positional relationship between the print head and the print medium in the second direction, each of the plurality of blocks including N linear patterns (N is an integer of 4 or more) to be formed so that an interval between two linear patterns adjacent in the first direction is constant;
acquiring a captured image by capturing a print image obtained by the printing the test chart;
calculating a theoretical value of the interval between the two linear patterns adjacent in the first direction;
calculating an actual value of an interval between the two linear patterns constituting a linear pattern pair on a basis of the captured image for each of (N−1) linear pattern pairs constituted by the N linear patterns included in each of the plurality of blocks, the linear pattern pair being a combination of the two linear patterns adjacent in the first direction;
calculating a first error, a second error, and an average error for each of (N−2) linear patterns excluding linear patterns at both ends among the N linear patterns included in each of the plurality of blocks, the first error being a difference between the theoretical value and an actual value for a first linear pattern pair, the second error being a difference between the theoretical value and an actual value for a second linear pattern pair, the average error being an average of the first error and the second error, the first linear pattern pair being one of two linear pattern pairs including each linear pattern excluding the linear patterns at both ends among the N linear patterns, and the second linear pattern pair being another of the two linear pattern pairs;
setting, for each of the plurality of blocks, an actual position of a linear pattern in which a minimum average error is obtained by the calculating the first error, the second error, and the average error among the (N−2) linear patterns as a reference position;
calculating an ideal position at which each linear pattern is to be formed, on a basis of the reference position;
calculating a difference in the first direction between the ideal position and the actual position based on the captured image for each linear pattern; and
determining whether or not a nozzle corresponding to each linear pattern is a defective nozzle on a basis of the difference.

2. The defective nozzle detection method according to claim 1, wherein in the calculating the ideal position, the ideal position is calculated on a basis of an actual value of an interval between a linear pattern corresponding to the reference position and a first adjacent linear pattern and an actual value of an interval between the linear pattern corresponding to the reference position and a second adjacent linear pattern, the first adjacent linear pattern and the second adjacent linear pattern being two linear patterns adjacent to the linear pattern corresponding to the reference position in the first direction.

3. The defective nozzle detection method according to claim 2, wherein in the calculating the ideal position, an average of the actual value of the interval between the linear pattern corresponding to the reference position and the first adjacent linear pattern and the actual value of the interval between the linear pattern corresponding to the reference position and the second adjacent linear pattern is calculated as an average actual interval, and the ideal position is calculated assuming that an interval between two linear patterns constituting each linear pattern pair is the average actual interval.

4. The defective nozzle detection method according to claim 1, wherein in the calculating the ideal position, an average of actual values for linear pattern pairs for which a difference between an actual value calculated by the calculating the actual value and a theoretical value calculated by the calculating the theoretical value is less than or equal to a predetermined threshold among the (N−1) linear pattern pairs is calculated as an average actual interval for each of the plurality of blocks, and the ideal position is calculated assuming that an interval between two linear patterns constituting each linear pattern pair is the average actual interval.

5. The defective nozzle detection method according to claim 1, wherein the test chart includes a first mark representing a first predetermined position in the first direction and a second mark representing a second predetermined position in the first direction,
the defective nozzle detection method includes extracting an image in a range between the first mark and the second mark in the first direction from the captured image, and
in the calculating the theoretical value, the theoretical value is calculated on a basis of a distance between the first mark and the second mark, a number of linear patterns to be included in an image extracted by the extracting the image in the range between the first mark and the second mark, and a number of blocks.

6. The defective nozzle detection method according to claim 1, wherein
the plurality of blocks is K blocks (K is an integer of 3 or more), and
the test chart is configured such that N linear patterns included in a Pth block are formed at positions shifted by a certain distance in the first direction from N linear patterns included in a (P−1)th block, the P being an integer of 2 or more and K or less.

7. A defective nozzle detection method of detecting a defective nozzle in a printing apparatus including a print head including a plurality of nozzles arranged in a first direction and configured to perform printing on a print medium by ejecting ink from the plurality of nozzles, the defective nozzle detection method comprising:
printing a test chart including a plurality of linear patterns to be formed by ejecting ink from the plurality of nozzles and configured to be divided into a plurality of blocks in a second direction orthogonal to the first direction while relatively moving a positional relationship between the print head and the print medium in the second direction, each of the plurality of blocks including N linear patterns (N is an integer of 4 or more) to be formed so that an interval between two linear patterns adjacent in the first direction is constant;
acquiring a captured image by capturing a print image obtained by the printing the test chart;
calculating a theoretical value of the interval between the two linear patterns adjacent in the first direction;
calculating an actual value of an interval between the two linear patterns constituting a linear pattern pair on a basis of the captured image for each of (N−1) linear pattern pairs constituted by the N linear patterns included in each of the plurality of blocks, the linear pattern pair being a combination of the two linear patterns adjacent in the first direction;
calculating a first error, a second error, and an average error for each of (N−2) linear patterns excluding linear patterns at both ends among the N linear patterns included in each of the plurality of blocks, the first error being a difference between the theoretical value and an actual value for a first linear pattern pair, the second error being a difference between the theoretical value and an actual value for a second linear pattern pair, the average error being an average of the first error and the second error, the first linear pattern pair being one of two linear pattern pairs including each linear pattern excluding the linear patterns at both ends among the N linear patterns, and the second linear pattern pair being another of the two linear pattern pairs;
setting a reference position for each of the plurality of blocks;
calculating an ideal position at which each linear pattern is to be formed, on a basis of the reference position;
calculating a difference in the first direction between the ideal position and the actual position based on the captured image for each linear pattern; and
determining whether or not a nozzle corresponding to each linear pattern is a defective nozzle on a basis of the difference,
wherein the plurality of blocks is K blocks (K is an integer of 3 or more),
the test chart is configured such that N linear patterns included in a Pth block are formed at positions shifted by a certain distance in the first direction from N linear patterns included in a (P−1)th block, the P being an integer of 2 or more and K or less,
for a first block, a Kth block, and a block in which a minimum average error obtained by the calculating the first error, the second error, and the average error is less than or equal to a predetermined threshold, in the setting the reference position, an actual position of a linear pattern in which a minimum average error is obtained by the calculating the first error, the second error, and the average error among the (N−2) linear patterns is set as the reference position, and
for a Qth block in which a minimum average error obtained by the calculating the first error, the second error, and the average error is larger than the predetermined threshold, in the setting the reference position, when an average error obtained by the calculating the first error, the second error, and the average error for a Jth linear pattern included in a (Q−1)th block is less than or equal to the predetermined threshold, and an average error obtained by the calculating the first error, the second error, and the average error for a Jth linear pattern included in a (Q+1)th block is less than or equal to the predetermined threshold, the reference position is set on a basis of an actual position of a linear pattern included in the (Q−1)th block and an actual position of a linear pattern included in the (Q+1)th block, the Q being an integer of 2 or more and (K−1) or less, and the J being an integer of 2 or more and (N−1) or less.

8. The defective nozzle detection method according to claim 7, wherein for the Qth block in which the minimum average error obtained by the calculating the first error, the second error, and the average error is larger than the predetermined threshold, in the setting the reference position, a gravity center position calculated from an actual position of a (J−1)th linear pattern included in the (Q−1)th block, an actual position of a Jth linear pattern included in the (Q−1)th block, an actual position of a (J+1)th linear pattern included in the (Q−1)th block, an actual position of a (J−1)th linear pattern included in the (Q+1)th block, an actual position of a Jth linear pattern included in the (Q+1)th block, and an actual position of a (J+1)th linear pattern included in the (Q+1)th block is set as the reference position.

9. A defective nozzle detection method of detecting a defective nozzle in a printing apparatus including a print head including a plurality of nozzles arranged in a first direction and configured to perform printing on a print medium by ejecting ink from the plurality of nozzles, the defective nozzle detection method comprising:
printing a test chart including a plurality of linear patterns to be formed by ejecting ink from the plurality of nozzles and configured to be divided into a plurality of blocks in a first direction while relatively moving a positional relationship between the print head and the print medium in a second direction orthogonal to the first direction, each of the plurality of blocks including N linear patterns (N is an integer of 4 or more) to be formed so that an interval between two linear patterns whose positions in the second direction are adjacent is constant;
acquiring a captured image by capturing a print image obtained by the printing the test chart;
calculating a theoretical value of the interval between two linear patterns whose positions in the second direction are adjacent;
calculating an actual value of an interval between the two linear patterns constituting a linear pattern pair on a basis of the captured image for each of (N−1) linear pattern pairs constituted by the N linear patterns included in each of the plurality of blocks, the linear pattern pair being a combination of the two linear patterns whose positions in the second direction are adjacent;
calculating a first error, a second error, and an average error for each of (N−2) linear patterns excluding linear patterns at both ends among the N linear patterns included in each of the plurality of blocks, the first error being a difference between the theoretical value and an actual value for a first linear pattern pair, the second error being a difference between the theoretical value and an actual value for a second linear pattern pair, the average error being an average of the first error and the second error, the first linear pattern pair being one of two linear pattern pairs including each linear pattern excluding the linear patterns at both ends among the N linear patterns, and the second linear pattern pair being another of the two linear pattern pairs;
setting, for each of the plurality of blocks, an actual position of a linear pattern in which a minimum average error is obtained by the calculating the first error, the second error, and the average error among the (N−2) linear patterns as a reference position;
calculating an ideal position at which each linear pattern is to be formed, on a basis of the reference position;
calculating a difference in the second direction between the ideal position and the actual position based on the captured image for each linear pattern; and
determining whether or not a nozzle corresponding to each linear pattern is a defective nozzle on a basis of the difference.

10. The defective nozzle detection method according to claim 9, wherein in the calculating the ideal position, the ideal position is calculated on a basis of an actual value of an interval between a linear pattern corresponding to the reference position and a first adjacent linear pattern and an actual value of an interval between the linear pattern corresponding to the reference position and a second adjacent linear pattern, the first adjacent linear pattern and the second adjacent linear pattern being two linear patterns adjacent to the linear pattern corresponding to the reference position in the second direction.

11. The defective nozzle detection method according to claim 10, wherein in the calculating the ideal position, an average of the actual value of the interval between the linear pattern corresponding to the reference position and the first adjacent linear pattern and the actual value of the interval between the linear pattern corresponding to the reference position and the second adjacent linear pattern is calculated as an average actual interval, and the ideal position is calculated assuming that an interval between two linear patterns constituting each linear pattern pair is the average actual interval.

12. The defective nozzle detection method according to claim 9, wherein in the calculating the ideal position, an average of actual values for linear pattern pairs for which a difference between an actual value calculated by the calculating the actual value and a theoretical value calculated by the calculating the theoretical value is less than or equal to a predetermined threshold among the (N−1) linear pattern pairs is calculated as an average actual interval for each of the plurality of blocks, and the ideal position is calculated assuming that an interval between two linear patterns constituting each linear pattern pair is the average actual interval.
